(19) United States
(12) Patent Application Publication
(10) Pub. No.: US 2015/0136850 A1
(43) Pub. Date: May 21, 2015

(54) CARD MEDIUM PROCESSING DEVICE

(71) Applicant: NIDEC SANKYO CORPORATION, Suwa-gun, Nagano (JP)

(72) Inventor: Fumihiko Akahane, Suwa-gun (JP)

(21) Appl. No.: 14/403,468

(22) PCT Filed: Dec. 27, 2013
(86) PCT No.: PCT/JP2013/085084

§ 371 Date: Nov. 24, 2014

(30) Foreign Application Priority Data
Mar. 29, 2013 (JP) 2013-072351
Mar. 29, 2013 (JP) 2013-073637

(51) Int. Cl. G06K 7/00; G06K 7/08

(52) U.S. Cl. CPC G06K 7/0095; G06K 7/084
USPC 235/438

(57) ABSTRACT

A card medium processing may include a medium transfer unit to transfer the card medium along a transfer path; a motor to drive the medium transfer unit; a magnetic head installed in an area of the insertion slot, the magnetic head structured to detect the magnetic record carrier of the card medium; a detection sensor to detect a presence and a position of the card medium in the transfer path; and a control unit to control a transfer of the card medium by driving the motor in accordance with a detection result of the detection sensor. If it is an abnormal transfer operation, the control unit is structured to, at the time of ejecting the card medium, supply a write current to the magnetic head to delete at least a part of magnetic information recorded on the magnetic record carrier of the card medium.

### CROSS REFERENCE TO RELATED APPLICATIONS

This is the U.S. national stage of application No. PCT/JP2013/085084 filed on 27 Dec. 2013. Priority under 35 U.S.C. §119(a) and 35 U.S.C. §365(b) is claimed from Japanese Application No. 2013-072351, filed 29 Mar. 2013; and Japanese Application No. 2013-073637, filed 29 Mar. 2013; the disclosures of which are also incorporated herein by reference.

### FIELD OF THE INVENTION

The present invention relates to a card medium processing device having a card transfer mechanism for taking in and ejecting a card medium such as a magnetic card, and a card medium processing method thereof.

### BACKGROUND

In general, a card reader installed in an ATM unit (Automated Teller Machine) or an automatic vending machine is structured in such a way as to read and write information of a card medium (hereinafter simply called a “card”) inserted through a card insertion slot. In such a card reader, there is provided a protection shutter positioned inside the card insertion slot, which prevents a foreign object other than a card from being inserted through the card insertion slot, and also prevents a card from being taken out for a fraudulent use by way of an illicit behavior of a third person. The protection shutter opens when a medium detection sensor detects a card having been inserted through the card insertion slot; and meanwhile, the protection shutter shuts at the time of detecting the card having been taken into a unit inside the card insertion slot.

A case described below exemplifies a possible fraudulent use by way of an illicit behavior of a third person. In the case where some failure happens in a mechanical component or an electrical system inside a device so that a card gets jammed and abnormally stopped just after a customer inserts the card through the card insertion slot, or in the case where a card medium gets stopped due to some intentional juggle by a third person; if the customer leaves the place in order to call an attendant while keeping the shutter open as it is, the third person picks up the card in the meantime. Such a fraudulent use (fraudulent obtainment) of a card is a conduct generally called a phishing scam (phishing).

There are proposed various card readers provided with a mechanism for prevention of such a phishing scam (for example, refer to Patent Document 1 and Patent Document 2). Essentially, those card readers are provided with a pullout-protection mechanism that prevents a card from being pulled out at the time when a wrongdoer removes a contrivance for phishing and tries to pull out the card jammed in the card reader.

Incidentally, as a card to be used in a finance institution such as a bank, for executing a cashless service, a personal authentication, and the like, there are a magnetic card in which a magnetic stripe is formed on a surface of a plastic substrate, and an IC card in which an integrated circuit chip is embedded on a surface of a plastic substrate. Then, a card reader (including a card reader/writer) is used for recording and reproducing magnetic data to/from the magnetic card, or sending and receiving electronic data to/from the IC card.

The card reader reads magnetic data stored in the magnetic card and newly writes magnetic data into the magnetic card, by means of having a magnetic head contact with and slide on the magnetic stripe on the surface of the magnetic card. Also, the card reader reads electronic data stored in the IC card and newly writes electronic data into the IC card, by means of having an IC contact point contact with and come in contact with a metal terminal (external terminal) on the surface of the IC card.

Incidentally, during recent years, there have appeared a banking card and a credit card for which a design-wise quality is pursued. As an example of those cards, some plastic cards have a transparent part. Although conventionally there has been a card provided with a transparent part located at an area specified according to standards (hereinafter called a transparent card according to the standards), in late years occasionally there also appears a card provided with a transparent part located at an area that is not definitely specified according to the standards (hereinafter called a transparent card not according to the standards). As a result, there are an increasing number of cases in which a transparent card not according to the standards cannot be processed for recording and reproducing data to/from the card by a conventional card reader so as to fall into an inoperable condition, and the card cannot normally be handled.

In a conventional card reader, an optical sensor is used for detecting a card position in a transfer path, in order to avoid an impact of a magnetic environment of a surrounding area onto sensitivity of the sensor, and an impact of temperature and humidity of the surrounding area as well onto the sensitivity of the sensor. Then, in the case where a transparent card not according to the standards is inserted, light passes through the transparent part when the card is internally transferred, so that it is difficult to detect a card position by the optical sensor for detecting a card position. Therefore, due to that reason, sometimes a CPU loses the card position (as a result of that, falling into an inoperable condition). To avoid falling into such a condition, a countermeasure is taken for keeping a downtime period to a minimum by way of an exclusive control (such as, promptly unloading the card outside) before falling into an inoperable condition, in such a way that a transparent card not according to the standards and the like; wherein it is uncertain whether the cards can normally be handled or not; are judged as abnormal cards; more specifically, as cards to/from which data cannot be recorded and reproduced; before taking in those cards internally.

In the meantime, if any transaction (such as, recording and reproducing magnetic/electronic data, or sending and receiving electronic data) is not carried out whenever an inserted transparent card is a card which does not conform to the standards and the card reader cannot deal with, there appears a problem that it is impossible to flexibly response to diversification of customer needs.

In other words, in association with an expansion of a card market, customer needs increase so as to make it possible to continue a process as much as possible (such as, while a process of reading electronic data being impossible, only a process of reading magnetic data is possible) even when a transparent card not according to the standards, as described above, is inserted. Notwithstanding such a situation with respect to the customer needs, if any transparent card not according to the standards is unconditionally not accepted at all, it is impossible to flexibly cope with diversification of the customer needs.

Then, there is proposed a card reader that is so structured as to detect a transparent card by adding a non-optical sensor besides the optical sensor mentioned above, for the purpose of avoiding a decrease in an operation efficiency of the card reader owing to a meaningless returning process at the time of handling the transparent card (refer to Patent Document 3).

Moreover, proposed in Patent Document 4 is a card reader configured in such a way that it is diagnosed whether or not a card transfer system has a malfunction.

### PRIOR ART DOCUMENTS

### Patent Documents

Patent Document 1: Japanese Unexamined Patent Application Publication No. 2006-155567

Patent Document 2: Japanese Unexamined Patent Application Publication No. 2011-164808

Patent Document 3: Japanese Unexamined Patent Application Publication No. 2009-199272

Patent Document 4: Japanese Unexamined Patent Application Publication No. 2006-155399

### SUMMARY OF INVENTION

### Problems to be Solved

Unfortunately, in conventional anti-card-phishing technology including the technology disclosed in Patent Document 1 and Patent Document 2 mentioned above, there exists only a method to counter a phishing scam by applying a countermeasure that prevents the card from being pulled out when it is judged that the phishing scam has happened.

In the case where a phishing scam is operated by force, only providing a mechanism physically for preventing a card from being pulled out leads to destruction of the mechanism and breakage of the card (even though the card is broken, magnetic data of the card is stolen when a wrongdoer obtains the card); and consequently, the data of the card is stolen by the wrongdoer. In this way, it is not sufficient as a countermeasure against a phishing scam to mechanically provide a mechanism for preventing the card from being pulled out.

At least an embodiment of the present invention provides a card medium processing device and a card medium processing method with which it is possible at least to avoid a fraudulent use of magnetic information even if a card medium is stolen by way of an illicit behavior.

Moreover, in the case of a card reader disclosed in Patent Document 3, unfortunately an additional component comes up as a necessity, in such a way that a non-optical sensor is installed in order to deal with a transparent card as described above, so that there appear disadvantages such as a cost disadvantage, a difficulty in applying a marketed product, and the like.

In the case of a card reader disclosed in Patent Document 4; while energy is applied to a motor, and a cycle of a signal (encoder pulse signal) from the motor, to be obtained as a result of that, is observed in order to make sure that a prescribed frequency is obtained, it is only judged whether or not a malfunction exists in a motor system.

Moreover, in the worst case, a transparent card is inserted into a device, and the device does not detect a presence of the card since the card is transparent. Then, the device gets into a situation of waiting for a next card to be inserted, and sometimes a failure happens in such a way that two cards are inserted into the device. Also, in the case where a card remains inside a device owing to an unexpected accident such as a power failure and the like, sometimes a sensor does not detect a transparent card and the like at the time when electric power is restored to start the device; and then occasionally, the device may get into a situation of waiting for a next card. Otherwise, under conditions of “a card maybe remains inside the device”, a motor is kept on driving for a while. Then, it is assumed that “ejecting the card is completed,” after driving the motor for some time to be considered sufficient for ejecting the card; and therefore, the motor is unnecessarily driven, or there appears a situation that the card is carelessly ejected if the card has actually existed.

At least an embodiment of the present invention provides a card medium processing device and a card medium processing method with which it is possible to detect whether a card medium remains inside a device or not at the time when electric power is restored to start the device after an unexpected accident such as a power failure and the like.

### Means to Solve the Problems

At least an embodiment of the present invention is a card medium processing device for carrying out a predetermined process for a card medium in which a magnetic record carrier for recording magnetic information is formed, characterized in that the card medium processing device comprising: a medium transfer unit for transferring a card medium along a transfer path, while the card medium being in contact, and the card medium having been inserted from an insertion slot; a motor for driving the medium transfer unit; a magnetic head installed in an area of the insertion slot, the magnetic head being for detecting the magnetic record carrier of the card medium; a detection sensor for detecting a presence and a position of the card medium in the transfer path; and a control unit for controlling a transfer of the card medium by way of driving of the motor in accordance with at least a detection result of the detection sensor; wherein, if it is judged to be an abnormal transfer operation in which the card medium is not normally transferred in a transfer operation of the card medium, at the time of ejecting the card medium out of the insertion slot, the control unit carries out a supply control of a write current in such a way as to delete at least a part of magnetic information recorded on the magnetic record carrier of the card medium, by means of supplying a write current to the magnetic head.

At least an embodiment of the present invention is a card medium processing method for a card medium processing device, comprising: a medium transfer unit for transferring a card medium along a transfer path, while the card medium being in contact, and the card medium having been inserted from an insertion slot; a motor for driving the medium transfer unit; a magnetic head installed in an area of the insertion slot, the magnetic head being for detecting a magnetic record carrier of the card medium; and a detection sensor for detecting a presence and a position of the card medium in the transfer path; wherein a transfer of the card medium is controlled by way of driving of the motor in accordance with at least a detection result of the detection sensor; and if it is judged to be an abnormal transfer operation in which the card medium is not normally transferred in a transfer operation of the card medium, at the time of ejecting the card medium out of the insertion slot, a supply control of a write current is carried out in such a way as to delete at least a part of magnetic information recorded on the magnetic record carrier of the card medium, by means of supplying a write current to the magnetic head.

At least an embodiment of the present invention is a card medium processing device for carrying out a predetermined process for a card medium comprising: a medium transfer unit for transferring a card medium along a transfer path, while the card medium being in contact, and the card medium having been inserted from an insertion slot; a motor for driving the medium transfer unit; a detection unit for detecting a turning state of the motor; a detection sensor for detecting at least a presence/absence of the card medium, among a presence and a position of the card medium in the transfer path; a storage unit for storing beforehand the amount of energy of the motor driven at the time of idle running with no card medium being transferred in the transfer path; and a control unit for drive-controlling the motor in accordance with at least a detection result of the detection sensor; wherein the control unit measures the amount of energy of the motor according to a detection result of the detection unit at the time of start-up of starting the card medium processing device, makes a comparison between the amount of energy measured and the amount of energy of the motor at the time of idle running, the latter amount of energy of the motor being stored in the storage unit, and then makes a judgment on whether or not the card medium exists in the device.

At least an embodiment of the present invention is a card medium processing method for a card medium processing device, comprising: a medium transfer unit for transferring a card medium along a transfer path, while the card medium being in contact, and the card medium having been inserted from an insertion slot; a motor for driving the medium transfer unit; a detection unit for detecting a turning state of the motor; a detection sensor for detecting at least a presence/absence of the card medium, among a presence and a position of the card medium in the transfer path; and a control unit for drive-controlling the motor in accordance with at least a detection result of the detection sensor; wherein the amount of energy of the motor, driven at the time of idle running when no card medium is transferred in the transfer path, is stored beforehand in a storage unit; he amount of energy of the motor is measured, according to a detection result of the detection unit at the time of start-up of starting the card medium processing device; and a comparison is made between the amount of energy measured and the amount of energy of the motor at the time of idle running, the latter amount of energy of the motor being stored in the storage unit; in order to make a judgment on whether or not the card medium exists in the device.

### Advantageous Effect of the Invention

According to at least an embodiment of the present invention, it is possible at least to avoid a fraudulent use of magnetic information (magnetic data) even if a card medium is stolen by way of an illicit behavior.

According to at least an embodiment of the present invention, even though there exists a card that is difficult to be detected, such as a transparent card and the like, inside a device, a subsequent process can be carried out after waiting for a command from a higher-level device if it is judged that the card exists inside the device. Therefore, it is possible to avoid ejecting a card medium carelessly.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a general overview of an information processing system according to an embodiment of the present invention.

FIG. 2 is a diagram that conceptually shows a configuration example of a higher-level device according to the present embodiment.

FIG. 3 is a block diagram showing a configuration example of a card reader as a card medium processing device according to the embodiment of the present invention.

FIG. 4 is a diagram that conceptually shows a configuration example around a card insertion slot of the card reader according to the present embodiment.

FIG. 5 is a diagram showing a general overview of a configuration of a pre-head, as a magnetic head for detecting a card, according to the present embodiment.

FIG. 6 is a block diagram showing a signal operation system of the pre-head, as a magnetic head for detecting a card, according to the present embodiment.

FIG. 7 includes diagrams for explaining a general overview of a supply control of a write current to the pre-head (magnetic head for detecting a card) according to the present embodiment.

FIG. 8 is a diagram showing a configuration example of an energy amount measurement & judgment unit according to the present embodiment.

FIG. 9 is a diagram showing changes in drive power (load) and speed at an acceleration time and a constant speed time, in a motor drive operation according to the present embodiment.

FIG. 10 is a sectional plan view briefly showing a structure of the card reader according to the embodiment of the present invention.

FIG. 11 is a longitudinal sectional view briefly showing a structure of the card reader according to the embodiment of the present invention.

FIG. 12 is a flowchart for explaining a process from a card insertion until an end of transaction, including a presence of an abnormal transfer operation (jam), in the card reader according to the present embodiment.

FIG. 13 is a flowchart for explaining a first example of a supply control process of a write current to a magnetic head, as an anti-phishing countermeasure, in the card reader according to the present embodiment.

FIG. 14 is another flowchart for explaining a second example of a supply control process of a write current to a magnetic head, as an anti-phishing countermeasure, in the card reader according to the present embodiment.

FIG. 15 is another flowchart for explaining a third example of a supply control process of a write current to a magnetic head, as an anti-phishing countermeasure, in the card reader according to the present embodiment.

FIG. 16 is another flowchart for explaining a fourth example of a supply control process of a write current to a magnetic head, as an anti-phishing countermeasure, in the card reader according to the present embodiment.

FIG. 17 is another flowchart for explaining a fifth example of a supply control process of a write current to a magnetic head, as an anti-phishing countermeasure, in the card reader according to the present embodiment.

FIG. 18 is another flowchart for explaining a sixth example of a supply control process of a write current to a magnetic head, as an anti-phishing countermeasure, in the card reader according to the present embodiment.

FIG. 19 is another flowchart for explaining a seventh example of a supply control process of a write current to a magnetic head, as an anti-phishing countermeasure, in the card reader according to the present embodiment.

FIG. 20 includes diagrams that explain timing when a detection signal of each sensor turns ON.

FIG. 21 includes diagrams that show how a card actually moves through a card transfer path.

FIG. 22 is a first flowchart for explaining an operation in relation to a detection signal of each sensor, in association with a card transfer, in the card reader according to the present embodiment.

FIG. 23 is a second flowchart for explaining an operation in relation to a detection signal of each sensor, in association with a card transfer, in the card reader according to the present embodiment.

FIG. 24 is a flowchart for explaining a card searching process at the time of start-up, in the card reader according to the present embodiment.

### DETAILED DESCRIPTION OF THE EMBODIMENTS

Embodiments of the present invention are explained below with reference to the accompanying drawings. An embodiment of the first invention is explained at first.

In the embodiment described below, an explanation is made by illustrating a card reader (including a card reader/writer) that is configured in such a way that information can be read and written from/to both a magnetic card and an IC card (in such a way as to have an information recording function in addition to an information reproducing function), by example, as a card medium processing device. Incidentally, in the present embodiment, an anti-phishing countermeasure against a fraudulent use of a card is taken as a measure for a magnetic card, as described later. Therefore, in the description below, the explanation is made on the assumption that, in an elementary sense, the card is a magnetic card, excluding an explanation about an IC contact block structural unit. Meanwhile, at least an embodiment of the present invention can be applied to, not only a card reader but also a card scanner, a card printer, and the like as electronic equipment.

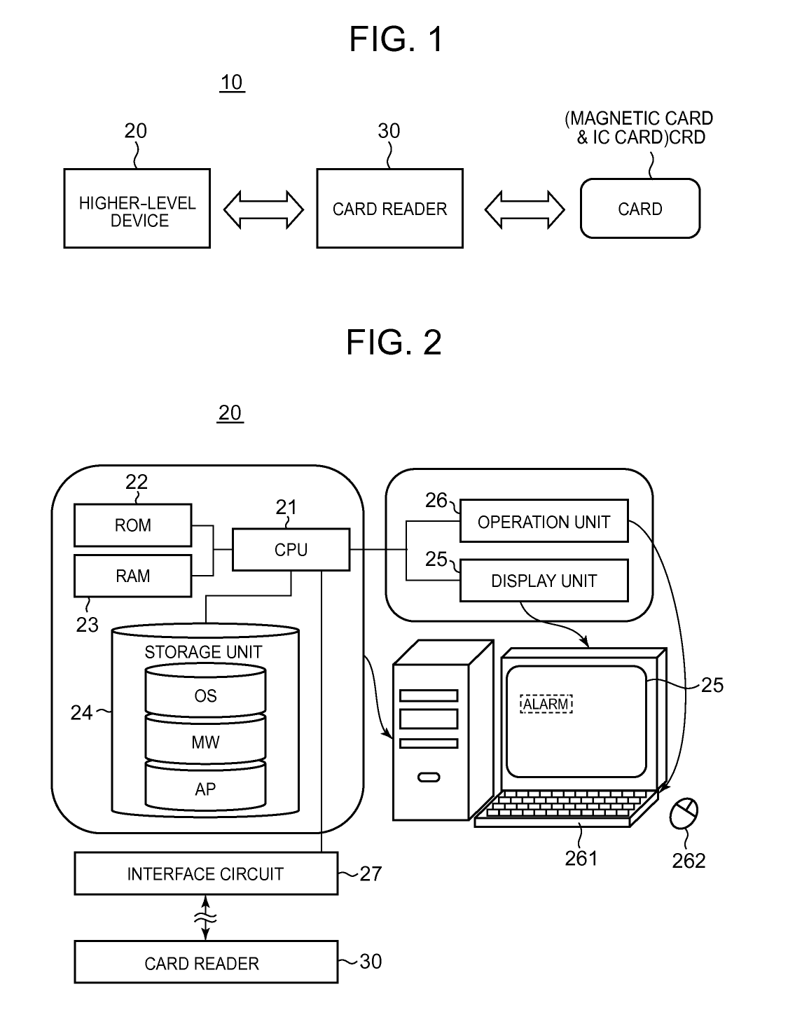

FIG. 1 is a block diagram showing a general overview of an information processing system according to an embodiment of the present invention.

An information processing system 10 is so configured as to include a higher-level device (a host unit) 20 as an information processing device, a card reader (an electronic device) 30 as a card medium processing device, and a card (a magnetic card or an IC card) CRD.

(Configuration and Function of Higher-Level Device)

The higher-level device 20 carries out a communication control at an interface with the card reader 30 for obtaining information from the card reader 30 by way of sending and receiving various information, such as receiving a response (a reply) corresponding to transmission of a command, and the like.

If an abnormal transfer, i.e. a so-called jam (jamming operation), happens in the card reader 30; for example, at the time of transferring the card CRD, a normal transfer becomes impossible owing to a phishing scam of a wrongdoer, or the card cannot normally be transferred because of a card form status or a card surface status (a transfer roller slipping because of oil, etc.); the higher-level device 20 receives information of the abnormal transfer and obtains the information. For example, at the time of turning on the power (at start-up), or re-starting by turning on the power after a power-off of the card reader 30 due to a power failure and the like, the higher-level device 20 receives information of a result of a card searching process to investigate a presence/absence of the card at a side of the card reader 30, to be described later, and obtains the information. While the card CRD is inserted into the card reader 30 and a predetermined transaction is carried out, the higher-level device 20 sends and receives information on an identification number of the card, transaction data, and the like to/from the card reader 30. If the higher-level device 20 obtains information from the side of the card reader 30 that the card CRD remains in the card reader (device), the higher-level device 20 sends an instruction (command) for instructing whether or not to eject the remaining card CRD, for example, to the card reader 30. On the other hand, having obtained the information that the card CRD remains in the card reader (device), the higher-level device 20 may also carry out an alarm process; such as, for example, indicating a warning on a display unit (including a warning by use of an LED, a lamp, and so on), sounding an alarm by way of an audio processor, and the like.

FIG. 2 is a diagram that conceptually shows a configuration example of a higher-level device according to the present embodiment. The higher-level device 20 shown in FIG. 2 is so configured basically as to include a CPU 21 as a processing unit, a ROM 22, a RAM 23, a storage unit 24, a display unit 25 for indicating information such as a warning, etc., an operation unit 26 including a keyboard 261 and a mouse 262, and an interface circuit 27 for sending and receiving information to/from the card reader 30.

In the present example, an operating system (OS), a middle-ware MW, and a program such as an application, which are saved in the storage unit 24 illustrated in the drawing, constitute a part of a software system; and they are deployed as so-called software of a computer (an electronic computer) on the RAM 23, at the time of executing operation.

A communication system using an exclusive line (a wired communication line) of RS232C, USB (Universal Serial Bus), and the like is applied to a usual communication between the higher-level device 20 and the card reader 30.

Described above are a configuration and a function of the higher-level device 20.

Then, described next are a configuration and a function of the card reader 30.

In the following section, explained first is a general overview of a configuration and a function of a signal processing system and a driving system in relation to a characteristic card transfer operation of the card reader according to the present embodiment. Then, explained next is a concrete configuration of a card transfer system and the like, of a magnetic card reader. A card reader (a card reader/writer) configured in such a way that writing data and reading data can be done with respect to both a magnetic card and an IC card (so as to have an information recording function together in addition to an information reproducing function), as described above, is illustrated by an example in the this section. In the meantime, a countermeasure against a phishing scam to fraudulently use a card is taken as a measure for a magnetic card.

(General Overview of Anti-Phishing Countermeasure)

In this section, explained at first is a general overview of an anti-phishing countermeasure being a characteristic configuration in the card reader 30 according to the present embodiment.

As described later in detail, according to the present embodiment, the card reader 30, which can deal with a magnetic card, includes a group of detection switches that can detect the card CRD having been inserted. The group of detection sensors includes a pre-head PH at an inserting section of the device (outside the device), the pre-head PH being a magnetic head which can judge whether or not magnetism exists, before taking in the card inserted. The pre-head (a magnetic head for card detection (magnetism detection)) also works as a writing head (write head) when the pre-head is supplied with electric current. In the card reader 30, the head for magnetism detection is supplied with electric current in order to materialize the magnetic writing function. Moreover, the card reader 30 has a judgment function to sense a status of a sensor and the like during a motor operation at the time of card transfer in the card reader 30, and to be able to judge that some card trapping has been set up for the card reader 30 when the card transfer is hindered (hereinafter, called a jam). In the case where it is judged that the trapping has been set up, a pre-head 401 (a magnetic head for card detection) is supplied with electric current, and then the magnetic head for card detection is provided with a writing function at the time. An algorithm to determine the timing when the electric current is supplied is a characteristic configuration of the card reader 30 according to the present embodiment.

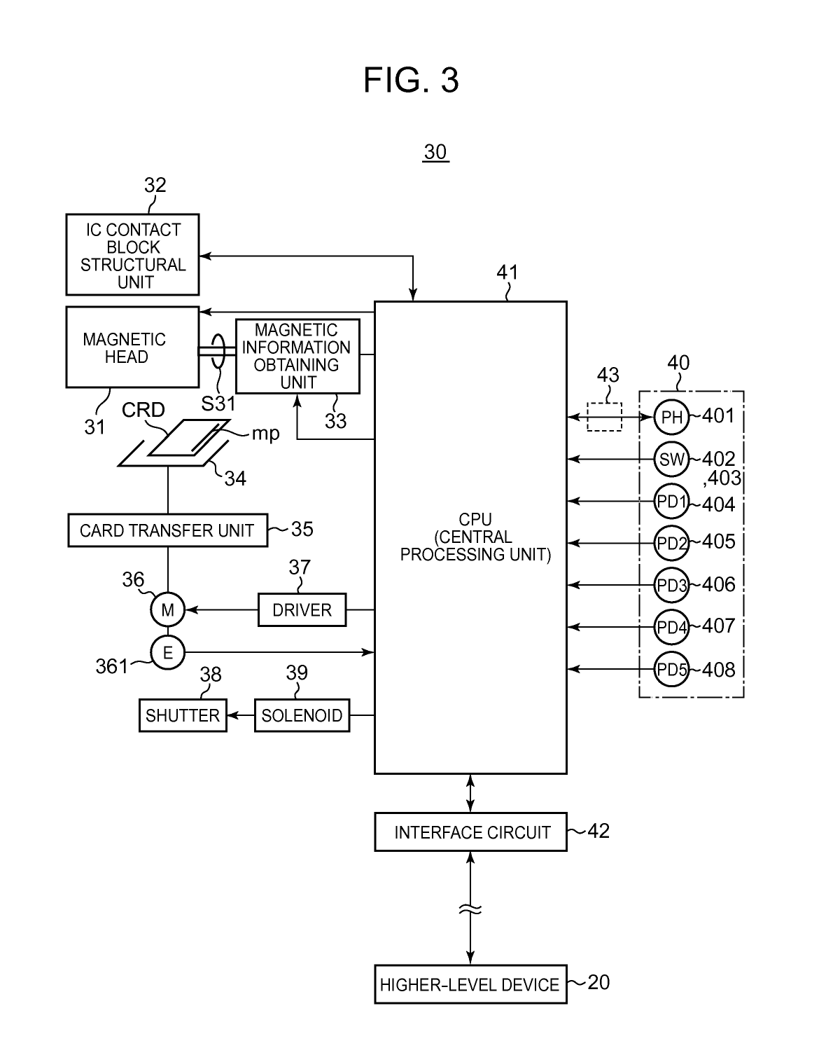

More concretely to describe, the card reader 30 can detect the card CRD having been inserted by means of a card-insertion detecting switch (sensor) 402 & 402 (refer to FIG. 3 and so on) turning ON from OFF; and in the meantime, the pre-head PH as a magnetic head placed around there can judge whether or not magnetic information (data) exists in the card inserted. Usually, in a fraudulent case (an illicit behavior) such as a phishing scam, a card is taken into a device first, and then it becomes impossible to eject the card at the time of ejecting the card externally again, after a transaction is finished, or the transaction is interrupted, and the like. Then, after an owner of the card gives up getting the card and leaves there, the card is taken away by use of a special measure (for a wrongdoer who have set up the phishing scam, it is well-known how to take out the trapped card). Eventually in this way, the card having magnetic information (magnetic data) is stolen, and the phishing scam ends up successfully.

The card reader 30 of the present embodiment includes an algorithm for detecting a phenomenon that seems a phishing scam, with respect to the magnetic information (the magnetic data) of the card to be taken away, and a configuration for deleting the magnetic data at the time. The card reader 30 is able to recognize whether or not the card CRD is normally being transferred, by using a plurality of sensors (each sensor of the group of detection sensors) that can detect a motor driving status of the card reader 30 and a card position. In the case where a phishing scam is set up to cause an abnormal transfer operation (card jam) in which the card cannot normally be transferred, it is possible to assume that the phishing scam has been set up. At the time, a phenomenon of the abnormal transfer operation (jam) might have happened owing not to any phishing scam but to a problem of a card form status or a card surface status (a transfer roller slipping because of oil, etc.). In this case, after retrying the transfer operation several times, the card reader 30 assumes that the phenomenon of the abnormal transfer operation has happened, and does not take a next action until a repair-service person and the like manually eliminates a problem of the abnormal transfer operation (jam). Therefore, essentially the card does not move any more.

On the other hand, in the case where a phishing scam (an illicit behavior) is set up, a wrongdoer comes up and tries to pull out the card from the device. Then, regardless of an intentions of the card reader 30, the card starts to move in the device; and as a result of that, a status of a sensor and the like changes and magnetic information (magnetic data) comes out through the magnetic head for card detection. In the case of detecting such a phenomenon, the card reader 30 supplies the pre-head PH, being a magnetic head located at the card inserting section, with electric current; and as a result of that, the magnetic information (magnetic data) of the card CRD passing through right below the head is deleted. As the magnetic head, a pre-existing magnetic head for magnetically reading/writing is used, as it is. With respect to an electric current to be supplied to the magnetic head, the above-mentioned operation can be materialized since a normal writing current can be switched as a current to be supplied. Accordingly, though the card may be stolen by the wrongdoer, the magnetic information (magnetic data) as a most important thing is already deleted so that the wrongdoer cannot use the stolen card any more as it is.

Furthermore, a synergetic effect is also expected by additionally providing a structure for mechanically preventing the card from being pulled out when an abnormal transfer operation (jam) happens. In that case, an algorithm is adopted in such a way that; if an abnormal transfer operation (jam) occurs, the card is locked at first by the mechanical structure; and then if it is judged that the card has further moved or has been moved under the condition, the magnetic head for magnetic detection is supplied with electric current.

(General Overview of Signal Processing System of Card Reader)

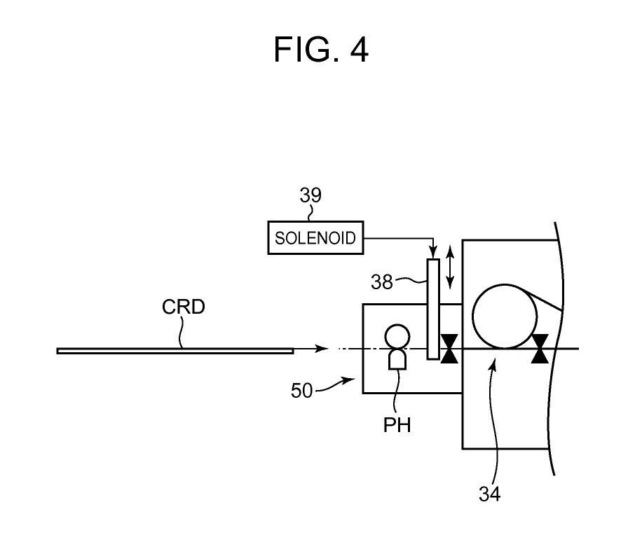

FIG. 3 is a block diagram showing a configuration example of a card reader as a card medium processing device according to the embodiment of the present invention. FIG. 4 is a diagram that conceptually shows a configuration example around a card insertion slot of the card reader according to the present embodiment.

As shown in FIG. 3, the card reader 30 includes; a magnetic head 31 for handling a magnetic card, an IC contact block structural unit 32 for handling an IC card, a magnetic information obtaining unit 33 including a differential amplifier circuit, a card transfer path 34, a card transfer unit 35 for transferring the card CRD along the card transfer path 34, and a motor (M) 36 equipped with an encoder (E) 361, wherein the motor (M) 36 is for driving the card transfer unit 35. The encoder (E) 361 works as a part of a detection unit for detecting a turning state (rpm and rotational position) of the motor 36. The card reader 30 includes, for example; a driver 37 for driving the motor 36 structured with a DC motor, a shutter 38 for opening/closing the transfer path at a card insertion slot 50, and a solenoid 39 for activating the shutter 38. Furthermore, the card reader 30 is so configured as to include; a group of detection sensors 40 for sensing a presence of the card CRD in the card transfer path 34 and detecting a transfer position of the card CRD, a CPU 41 as a control unit, an interface circuit 42, and a read-write circuit 43 for reading/writing operation of the magnetic head for card detection (pre-head) PH.

The magnetic head 31 reads out magnetic-record information as an analog signal S31, which is recorded in a magnetic stripe ‘mp’ that is a magnetic record carrier of the card CRD as a magnetic recording medium, wherein the magnetic-record information is recorded, for example, by way of an F2F modulation method. The analog signal S31 as magnetic-record information read out by the magnetic head 31 is supplied to the magnetic information obtaining unit 33. Moreover, the magnetic head 31 writes magnetic-record information into a magnetic stripe ‘mp’ of the card CRD. The magnetic head 31 placed in the card transfer path 34 operates in the case where an inserted card is a magnetic card, and the magnetic head 31 reads and writes magnetic data by contacting with and sliding on a magnetic stripe on a surface of the card.

The IC contact block structural unit 32 operates in accordance with a control by the CPU 41, in the case where the inserted card is an IC card. The IC contact block structural unit 32 has an IC contact point that can contact with/come in contact with a metal terminal (external terminal) on a surface of the IC card, along the card transfer path 34; and then electronic data is read out and written in when the IC contact point and the metal terminal contact with/come in contact with each other.

In the magnetic information obtaining unit 33, the differential amplifier circuit configured with an operational amplifier amplifies the analog signal S31, read out and reproduced by the magnetic head 31, up to an appropriate level, under a gain control by the CPU 41. The differential amplifier circuit conducts the gain control, for example, in such a way as to set amplitude of the signal a quarter of a full range. Incidentally, the differential amplifier circuit can be so configured as to have an auto gain control (AGC) function.

Moreover, the magnetic information obtaining unit 33 has a function to read out magnetic information, recorded in the card CRD, from a magnetic signal that is output from the differential amplifier circuit and detected by the magnetic head 31, and to demodulate the signal. The magnetic information obtaining unit 33 is so configured, for example, as to include a peak detection circuit and a demodulation circuit.

An output signal from the differential amplifier circuit is input into the peak detection circuit, for example, by the intermediary of a band-pass filter and the like. The output is reversed at a peak point of the amplified signal so as to obtain a rectangular wave signal that is frequency-modulated (by way of F2F modulation). The demodulation circuit carries out digital signal processing on the rectangular wave signal; and obtains, for example, a read clock signal (a clock pulse for demodulation data sampling) which is output at a bit separation, as well as a read data signal (demodulation data) representing data of the bit; and outputs those signals to the CPU 41 and furthermore to the interface circuit 42.

Incidentally, various kinds of circuits such as a differentiation circuit, an integration circuit, a digital method circuit, and the like can be applied to the peak detection circuit. Meanwhile, various kinds of method such as the so-called one-shot method, a multiple interval method, a pattern matching method, and the like can be applied to the demodulation circuit.

In the card transfer path 34, there are placed the magnetic head 31 and the like. Then, by the card transfer unit 35, the card CRD is transferred toward an installation position of the magnetic head 31, or in a direction getting away from the installation position of the magnetic head 31.

The card transfer unit 35 transfers the card CRD along the card transfer path 34, by driving operation of the motor 36 by way of the driver 37.

The motor 36 is driven by the driver 37 controlled by the CPU 41, so as to drive the card transfer unit 35 for transferring the card CRD. As a control method for the motor 36, for example, a PWM control method is adopted, and then the motor 36 is PWM-controlled by the CPU 41.

The shutter 38 is placed in the card transfer path 34, around an area of the card insertion slot 50 of the card reader 30, in order to open/close the card transfer path 34 at the card insertion slot 50 of the card reader 30, in accordance with an activation status of the solenoid 39 with its activation controlled by the CPU 41. Opening/closing the shutter 38 is controlled by the CPU 41, on the basis of a detection result by the magnetic head for card detection (the pre-head PH), in such a way as to keep its closed condition to stop taking in a card, for example, in the case where the card CRD inserted is a fraudulent card, and meanwhile to open in order to allow the card CRD to pass by if the card CRD is a proper card. In a usual case, at the time of operating the card reader 30, a customer inserts the card CRD of a magnetic card method, such as a credit card, a prepaid card, and the like, through the card insertion slot 50, at a shop front. With respect to the card CRD inserted, a magnetic stripe ‘mp’ of the card is detected at first by the magnetic head for card detection PH. If the CPU 41 judges by way of detecting the magnetic stripe ‘mp’ that the card inserted is a proper card, the solenoid 39 gets activated according to the signal to open the shutter 38. Then, as the shutter is opened, the card CRD is pushed further into a deeper section by a customer's operation.

As being explained later in relation to a structure, the group of detection sensors 40 is placed along the card transfer path 34, and structured so as to include the pre-head (PH, i.e., the magnetic head for card detection) 401, a lever 402, a micro-switch (SW) 403, and a plurality of photo-sensors (optical sensors) (PD1 through PD5) 404 through 408. Each of the group of detection sensors 40 is placed in this order; the pre-head (PH, i.e., the magnetic head for card detection) 401, the lever 402 & the micro-switch (SW) 403, and the plurality of photo-sensors (optical sensors) (PD1 through PD5) 404 through 408; in a direction starting from a side of the card insertion slot 50.

As the card CRD inserted through the card insertion slot 50 is taken in, the pre-head 401 recognizes a fact of taking in the card by detecting magnetism; concretely to describe, by detecting magnetism with the magnetic stripe ‘mp’ as a magnetic record carrier; and sends a signal, which is a cue for starting the drive motor 36, to the CPU 41. Then, having received the signal, the CPU 41 sends a starting signal to the drive motor 36 so that the card CRD inserted is taken in (transferred). Then, the card CRD inserted is transferred into a deeper section of the card transfer path 34, by drive rollers 353d through 353f that makes up the card transfer unit 35.

The pre-head 401 is installed at the card insertion slot 50, as the magnetic head for card detection in the elementary sense. In the present embodiment, the CPU 41 carries out a supply control of a write current in such a way that the pre-head 401 deletes at least a part of magnetic information of the magnetic stripe ‘mp’ of the card CRD under a predetermined condition, to be described later in detail, in order to make it possible to avoid at least a fraudulent use of the magnetic data even though the card CRD is stolen by way of an illicit behavior by a phishing scam.

Namely, the pre-head 401 is so configured as to be able to carry out writing (deleting) information in addition to reading information, in the same way as the magnetic head 31.

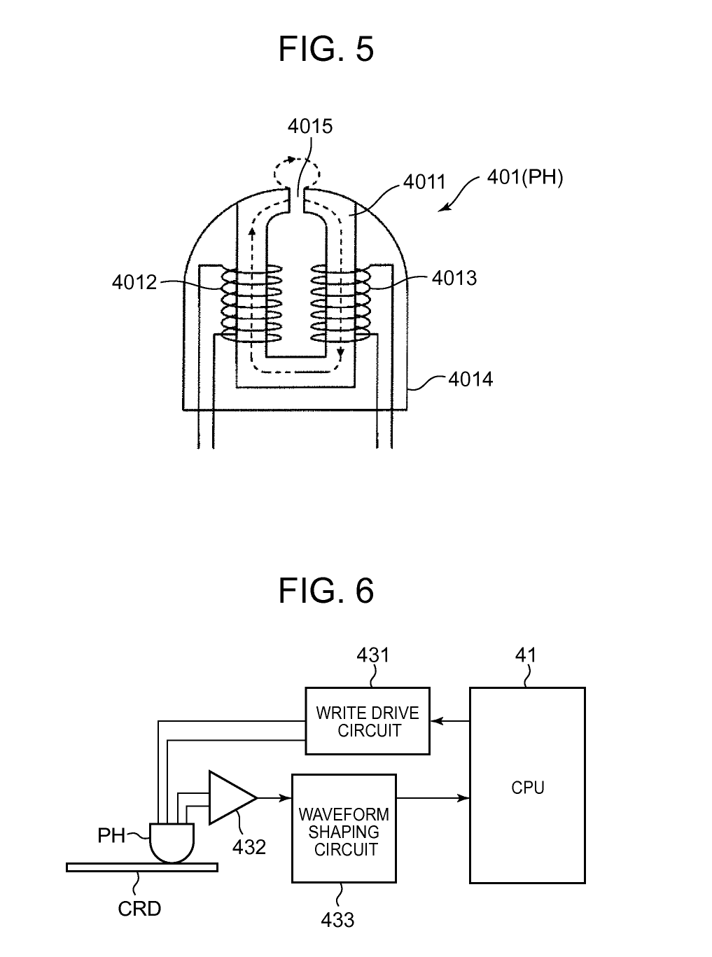

FIG. 5 is a diagram showing a general overview of a configuration of a pre-head, as a magnetic head for detecting a card, according to the present embodiment. FIG. 6 is a block diagram showing a signal operation system of the pre-head, as a magnetic head for detecting a card, according to the present embodiment.

As shown in FIG. 5, the pre-head 401 (PH) is so configured as to include; magnetic cores 4011 that are placed face to face across a magnetic gap (magnetic spacer) 4015; a winding wire for writing 4012 (a primary coil), wound on the magnetic core 4011; a winding wire for reading 4013 (a secondary coil), wound on the magnetic core 4011; and a case 4014 for housing the above components.

A configuration is established in such a way that a write current for writing or deleting magnetic information to/from a magnetic card flows through the winding wire for writing 4012; and in the meantime, a current by way of a magnetic induction flows through the winding wire for reading 4013 in accordance with a change of magnetic flux in the proximity of the magnetic gap 4015. When a write current flows through the winding wire for writing 4012, an induced flux is generated in the winding wire for writing 4012, and moreover an induced flux is also generated in a magnetic path formed along the magnetic core 4011. Then, due to the induced flux generated in the magnetic path formed along the magnetic core 4011, a magnetic flux changes in the proximity of the magnetic gap 4015 so that an induced current is generated by way of a magnetic induction in the winding wire for reading 4013.

The pre-head 401 provided with a configuration described above is activated by the read-write circuit 43 under control of the CPU 41, as shown in FIG. 6. The read-write circuit 43 includes a write drive circuit 431, an amplifying unit (amplifier) 432, a waveform shaping circuit (such as a band-pass filter, a comparator, and the like) 433; and the read-write circuit 43 has a function for supplying a write current to the winding wire for writing 4012 as well as detecting a read current (including the induced current described above) generated in the winding wire for reading 4013. More concretely to describe, the write drive circuit 431 connected to the winding wire for writing 4012 supplies the winding wire for writing 4012 with a write current, on the basis of a write signal of magnetic information from the CPU 41. When information is deleted, the winding wire for writing 4012 is supplied with a write current that remains constant (for example, to be fixed to North pole). On the other hand, the amplifier 432 connected to the winding wire for reading 4013 detects the read current described above, and then amplifies the amplitude of a waveform and outputs the data. Then, the output from the amplifier 432 passes through the waveform shaping circuit 433; and after removing a high-frequency noise and waveform shaping, the output is input into the CPU 41 as a read signal (readout signal).

While recognizing a position and the like of the card CRD, detected by using each detection sensor of the group of detection sensors 40, in the card transfer path 34, the CPU 41 carries out; a drive control for the motor 36; recognition processing on a presence and a position of the card; control processing of the card transfer; and a control of read processing and write processing of information (data) from/to the card CRD. The CPU 41 carries out a gating control of the shutter 38, in accordance with a detection result on magnetic information (a magnetic signal) by using the pre-head PH. In the case where the card CRD inserted is an IC card, the CPU 41 carries out an activation control of the IC contact block structural unit 32, and a control of sending/receiving information to/from an IC of the card side through a contact point.

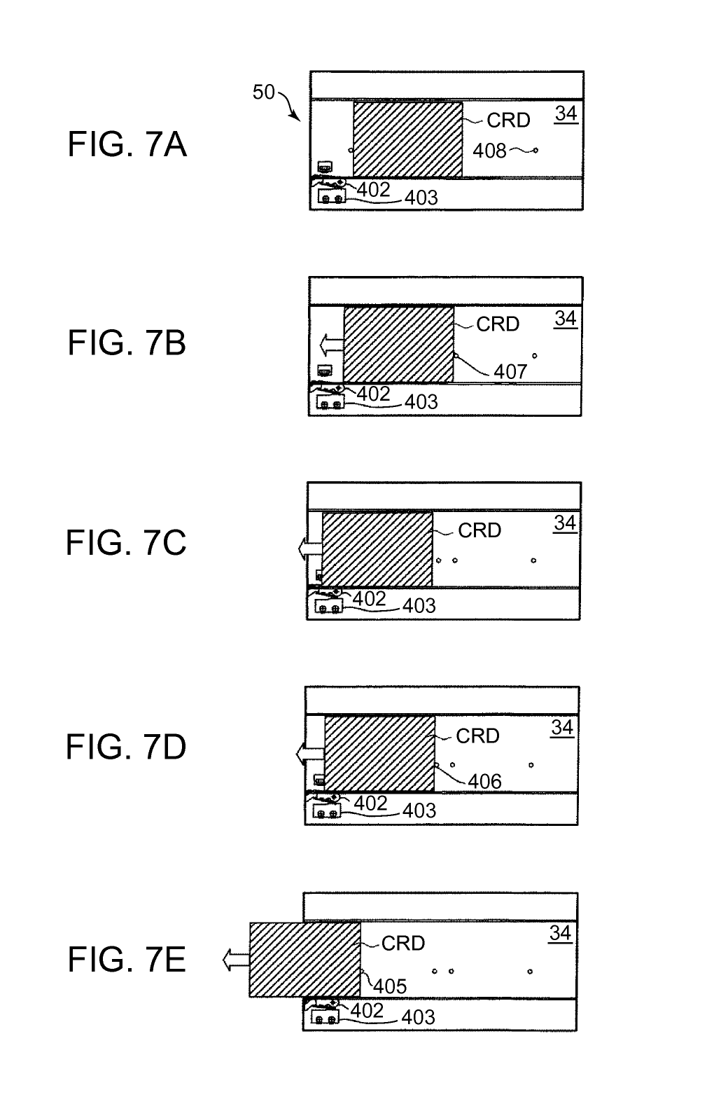

In the case where it is judged to be an abnormal transfer operation (in the present embodiment, such a condition is sometimes called a ‘jam’) in which the card CRD is not normally transferred; at the time of ejecting the card CRD out of the card insertion slot 50, the CPU 41 carries out the supply control of a write current to the pre-head 401 (the magnetic head for card detection) in a control of transferring the card in the card transfer path 34 (the supply control′ is explained below with reference to FIG. 7).

FIG. 7 includes diagrams for explaining a general overview of a supply control of a write current to the pre-head (magnetic head for card detection) according to the present embodiment. FIG. 7A through 7E show a case example in which the card CRD is pulled out toward a side of the card insertion slot 50 after it is judged that an abnormal transfer operation (jam) happens at the time of transferring the card CRD in the card transfer path 34 of the card reader 30 according to the present embodiment. As described above, in this case example, each of the group of detection sensors 40 is placed in this order; the pre-head (PH, i.e., the magnetic head for card detection) 401, the switch (SW) 402 & the lever 403, and the plurality of photo-sensors (optical sensors) (PD1 through PD5) 404 through 408; in a direction starting from a side of the card insertion slot 50.

FIG. 7A shows a case example in which an abnormal transfer operation (jam) happens halfway in the card transfer path 34 so that the card CRD remains inside the card reader 30. This case shows a situation where the card CRD remains above installation positions of the photo-sensors 405, 406, and 407. FIG. 7B shows a situation where a wrongdoer of a phishing scam applies a force to pull out the card CRD toward the side of the card insertion slot 50 so that the card CRD is displaced from the installation position of the photo-sensor 407 and moved to a location above the installation position of the photo-sensor 404 at the side of the card insertion slot 50, and the photo-sensors 405 and 506. FIG. 7C shows a situation where the wrongdoer of a phishing scam applies a force to further pull out the card CRD toward the side of the card insertion slot 50 so that the card CRD is displaced from the installation position of the photo-sensor 406 and moved to a location above a part the pre-head 401 at the side of the card insertion slot 50, and the installation positions of the photo-sensors 404 and 405. FIG. 7D shows a situation where the wrongdoer of a phishing scam applies a force to further pull out the card CRD toward the side of the card insertion slot 50 so that the card CRD is displaced from the installation position of the photo-sensor 406 and moved to a location above a central part in a longitudinal direction of the pre-head 401 at the side of the card insertion slot 50, and the installation positions of the photo-sensors 404 and 405. FIG. 7E shows a situation where the wrongdoer of a phishing scam applies a force to further pull out the card CRD toward the side of the card insertion slot 50 so that the card CRD is displaced from the installation position of the photo-sensor 405 and moved to a location above an entire part of the pre-head 401 at the side of the card insertion slot 50, and the installation position of the photo-sensor 404. In this situation, nearly a half of the card CRD has been pulled out from the card insertion slot 50.

In the case where it is judged to be an abnormal transfer operation (jam), for example, as shown in FIG. 7A; at the time of ejecting the card CRD out of the card insertion slot 50, the CPU 41 basically carries out the supply control of a write current in such a way as to delete at least a part of magnetic information recorded on the magnetic stripe ‘mp’, being a magnetic record carrier of the card CRD, by means of supplying a write current to the pre-head 401 (the magnetic head for card detection).

For example, a method in which a detection of a card by a photo sensor positioned at a side of the card insertion slot 50, is used as a trigger, can be adopted as a method for detecting an unloading operation of the card CRD having started, after a judgment of an abnormal transfer operation (jam). In this case, after the judgment of an abnormal transfer operation (jam) at the card position shown in FIG. 7A; when the photo-sensor 404 detects the card CRD under the situation shown in FIG. 7B (meanwhile, the photo-sensor 407 does not detect the card CRD any more), the CPU 41 starts the supply control of a write current to the pre-head 401 (the magnetic head for card detection).

The supply control of a write current gets started. If supplying an electric current starts immediately at the time of starting the supply control of a write current, in the present embodiment, the electric current is supplied before the card CRD arrives at the installation position of the pre-head 401, so that an electric power is consumed wastefully. Therefore, in the present embodiment, in order to supply an electric current only in a time period that really needs an electric power so as to reduce power consumption, a configuration may be established in such a way that the CPU 41 starts to supply a write current to the pre-head 401 at the time when the card CRD is transferred in a direction toward the side of the card insertion slot 50 for getting ejected, as shown in FIG. 7C, and the pre-head 401 detects a magnetic signal of the magnetic stripe ‘mp’ that is a magnetic record carrier. Thereafter, as FIG. 7D and FIG. 7E show, the card CRD gets further ejected in the direction toward the side of the card insertion slot 50, and in association with the operation, the magnetic information recorded on the magnetic stripe ‘mp’ of the card CRD is deleted.

Moreover, for a reason such that a wrongdoer does not necessarily pull out a card with a constant force in a smooth manner, the CPU 41 may carry out an intermittent current-supply operation in such a way, for example, as to supply a write current to the pre-head 401 for a predetermined time, e.g., five seconds, and then to subsequently stop supplying the write current. Also, a configuration may be established in such a way that the CPU 41 repeats a supply control of a write current, subsequent to the judgment of an abnormal transfer operation, described above, including this intermittent current-supply operation. By adopting an intermittent current-supply operation in this way, it is possible to further reduce the power consumption.

For example, a method of using a fact that; owing to a predetermined force applied to the card CRD in the direction toward the side of the card insertion slot 50, a load is applied to the motor 36 for operating the card transfer unit 35 so as to increase the amount of energy of the motor 36; as a trigger, can also be adopted as a method for detecting an unloading operation of the card CRD having started, after a judgment of an abnormal transfer operation (jam). In this case, after the judgment of an abnormal transfer operation (jam) at the card position shown in FIG. 7A; at the time of detecting the amount of energy of the motor 36 having been increased, since a predetermined force is applied to the card CRD in the direction toward the side of the card insertion slot 50 (in a direction toward a position shown in FIG. 7B), the CPU 41 starts the supply control of a write current to the pre-head 401 (the magnetic head for card detection).

The CPU 41 measures the amount of energy (load) of the motor 36, after the judgment of an abnormal transfer operation (jam), corresponding to an output of the encoder 361 as a detection unit for detecting a turning state (rpm and rotational position) of the motor. Then, the CPU 41 makes a comparison between the measured amount of energy and the amount of energy of the motor, which is stored in a storage unit; wherein the amount of energy stored in the storage unit is corresponding to either an abnormal transfer operation in which the card is not normally transferred through the card transfer path 34, or a normal transfer operation; in order to judge whether or not the remaining card is transferred toward the side of the card insertion slot 50. Then, it is determined by using this judgment whether or not to start the supply control of a write current to the pre-head 401.

In other words, after the judgment of an abnormal transfer operation (jam); for example, under conditions where the detection sensor is not sensing the card CRD (in a situation shown in FIG. 7A), the CPU 41 makes a comparison between a first energy amount obtained by way of measuring the amount of energy of the motor and a second energy amount of the motor stored in the storage unit, on the basis of a detection result of the encoder 361 working as a detection unit. Then, in the case where the first energy amount measured becomes greater than the second energy amount that has been stored, the CPU 41 judges that the card CRD is transferred toward the side of the card insertion slot 50, and then starts the supply control of a write current to the pre-head 401 by using this judgment as a trigger.

In this way, the CPU 41 can make a judgment on whether or not the amount of energy (load) of the motor increases, as a trigger for starting the supply control of a write current. Incidentally, it is also possible to adopt another configuration in such a way that a method of using a detection result of a detection sensor as a trigger for starting the supply control of a write current, as described above, is applied in combination.

Moreover, in the present embodiment, a configuration described below can also be adopted. That is to say; a configuration may be established in such a way that; after starting a supply of a write current to the pre-head 401, the CPU 41 makes a comparison between the first energy amount obtained by way of measuring the amount of energy of the motor 36 and the second energy amount of the motor, stored in the storage unit, on the basis of a detection result of the encoder 361 working as a detection unit; and then, in the case where the first energy amount measured has decreased toward the second energy amount that has been stored (a neighborhood value around the second energy amount), the supply of the write current to the pre-head 401 is stopped.

Moreover, a configuration may be established in such a way that; after stopping the supply of the write current to the pre-head 401, the CPU 41 makes a comparison between the first energy amount obtained by way of measuring the amount of energy of the motor 36 and the second energy amount of the motor stored in the storage unit, on the basis of a detection result of the encoder 361 working as a detection unit; and then, in the case where the first energy amount measured becomes greater than the second energy amount that has been stored, the supply of the write current to the pre-head 401 resumes.

It is also possible to establish a configuration in such a way as to make a combination of steps of stopping and resuming the current supply, for example, as to repeat those steps. Moreover, these steps can be carried out, being either independent from, or in combination with, the intermittent current-supply operation at a predetermined time interval as described above. This kind of configuration produces a benefit of an efficient control of power consumption.

In the present embodiment, a DC motor is used as the motor 36, as described above; and in a method applied for controlling a motor speed, the amount of energy to a motor drive system is fed back, on the basis of a period of a pulse signal from the motor (an encoder pulse). Incidentally, as the amount of energy to a motor drive system, it is possible to store statistical data under a constant-speed control, excluding an accelerating control (such as, at the time of starting operation, braking control for stop, and changing the speed), in a memory unit 413. Meanwhile, it is possible to become aware of the amount of power at the time of transferring a card, idle running (a state with no card in the device), and an abnormal transfer operation, in advance. Incidentally, it is possible to quantify “the amount of energy to a motor drive system” in accordance with, for example, a time period of “ON” within a certain time by ON/OFF operation of a motor drive circuit (driver). Alternatively, while controlling the voltage to be applied to the motor by way of a D/A (Digital/Analog) converter, a CPU can materialize quantification of the amount of power by using an average of the applied voltage.

As described above, the CPU 41 can become aware of the applied amount of energy by use of a value that is sequentially quantified, as a motor driving state. When the amount of energy in a very short time period is observed; the amount of energy (load) ‘MENG’ at the time when the card CRD is pulled out with a great force against the will of the device is significantly different (for example; greater) in comparison with the amount of energy ‘CENG’ that is applied to the motor 36 being driven at a constant speed or in an abnormal transfer operation, and is obtained by way of past statistics.

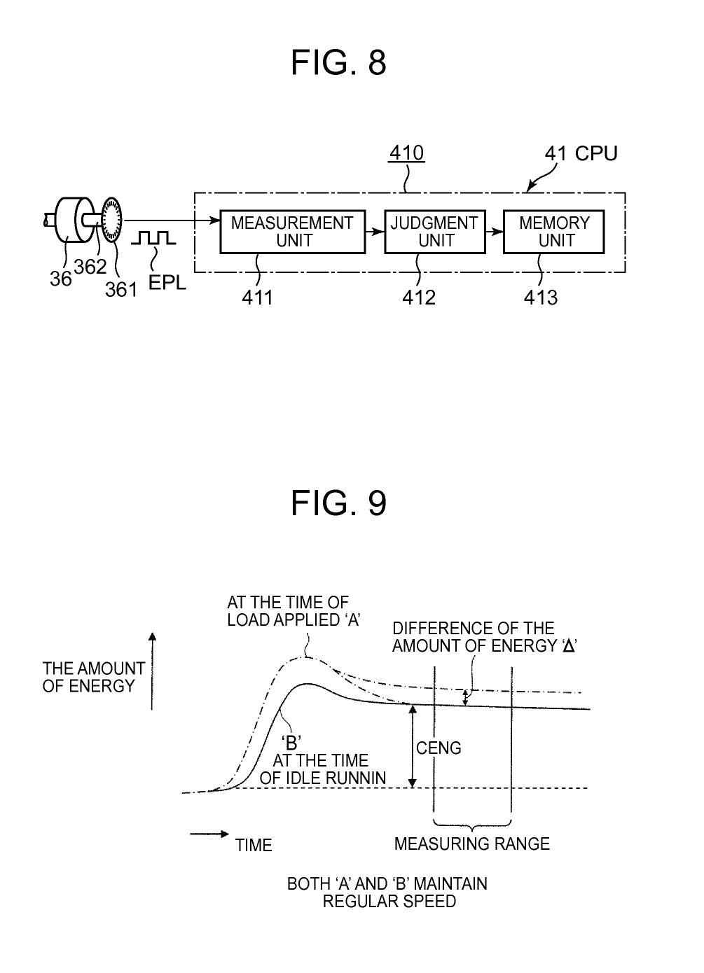

FIG. 8 is a diagram showing a configuration example of an energy amount measurement & judgment unit according to the present embodiment. FIG. 9 is a diagram showing changes in drive power (load) and speed at an increasing-load time, such as an acceleration time, and a constant speed time, in a motor drive operation according to the present embodiment of the first invention. In FIG. 9, a curve line ‘A’ shows the change in the power, and in the meantime, a curve line ‘B’ shows the change in the speed as well as the amount of energy according to the speed. The amount of energy ‘CENG’ shown in FIG. 9 represents the second energy amount of the motor at a constant speed under a normal transfer operation, or in an abnormal transfer operation (jam); the second energy amount of the motor being calculated statistically. By making a comparison between the second energy amount ‘CENG’ and the first energy amount ‘MENG’ measured, it is judged whether or not to start the supply control of a write current to the pre-head 401.

The energy amount measurement & judgment unit 410 shown in FIG. 8 is so configured as to include a measurement unit 411, a judgment unit 412, and the memory unit 413 as a storage unit.

Being arranged on a coaxial position, i.e., on the same axis position as an output shaft 362 of the drive motor 36, there is placed the encoder 361 as a means for detecting a motor turning speed (a detection unit). From the encoder 361, a signal EPL of a turning pulse is sent to the measurement unit 411 of the energy amount measurement & judgment unit 410 of the CPU 41.

The measurement unit 411 measures the amount of energy ‘CENG’ at the time when the drive motor 36 gets into a predetermined state, according to an output of the encoder 361 as a detection unit for detecting a turning state (rpm and rotational position) of the drive motor 36.

The judgment unit 412 makes a comparison between the first energy (load) amount ‘MENG’ measured by the measurement unit 411 and the second energy amount ‘CENG’ statistically-calculated of the motor at a constant speed under a normal transfer operation, or in an abnormal transfer operation (jam); the second energy amount ‘CENG’ being stored in the memory unit 413, and then makes a judgment on whether or not to start the supply control of a write current to the pre-head 401. For example, if the energy amount ‘CENG’ measured is greater than the energy amount ‘IENG’ at a constant speed, or in an abnormal transfer operation (jam), the judgment unit 412 makes a judgment that the card CRD is about to be pulled out with a great force against the will of the device, and then judges that the supply control of a write current to the pre-head 401 should get started.

The memory unit 413 stores (to store memory) the amount of energy (load) of the motor either at a statistically calculated constant speed under a normal operation in transferring the card CRD by the drive motor 36, or in an abnormal transfer operation (jam), in advance.

In the present embodiment, the amount of energy ‘ENG’ can be replaced with an rpm at the time when a turning speed of the drive motor 36 reaches a steady speed (constant speed) at a constant rpm, within a predetermined time range after a start of operation. The CPU 41 can be configured in such a way as to judge whether or not to start the supply control of a write current to the pre-head 401, by way of comparing the rpm measured with an rpm specified as an appropriate value in advance.

Moreover, the CPU 41 can be configured in such a way as to issue a warning (alarm) through a display unit and an audio processor, which are not illustrated; in the case where it is judged that an abnormal transfer operation (jam) has happened in the card reader 30, and the higher-level device 20 is informed of the judgment, and then the CPU 41 receives an alarm command in response to the judgment from the higher-level device 20.

Furthermore, the card reader 30 is connected to the higher-level device 20 by the intermediary of the interface circuit 42 as well as a communication line, in order to send information of, for example, demodulation data, card transfer conditions, and the like, to the higher-level device 20. As the interface circuit 42, various communication methods such as, RS232C method, Parallel Port method, USB connection method, and the like are adopted, as described above, in order to establish a communication between the higher-level device 20 and the card reader 30.

Described above is a general overview of a configuration and a function of a signal processing system and a driving system in relation to a card transfer operation of the card reader 30 according to the present embodiment. Then, explained next is a concrete configuration of a card transfer system and the like, of the card reader 30.

(Structure of Card Reader)

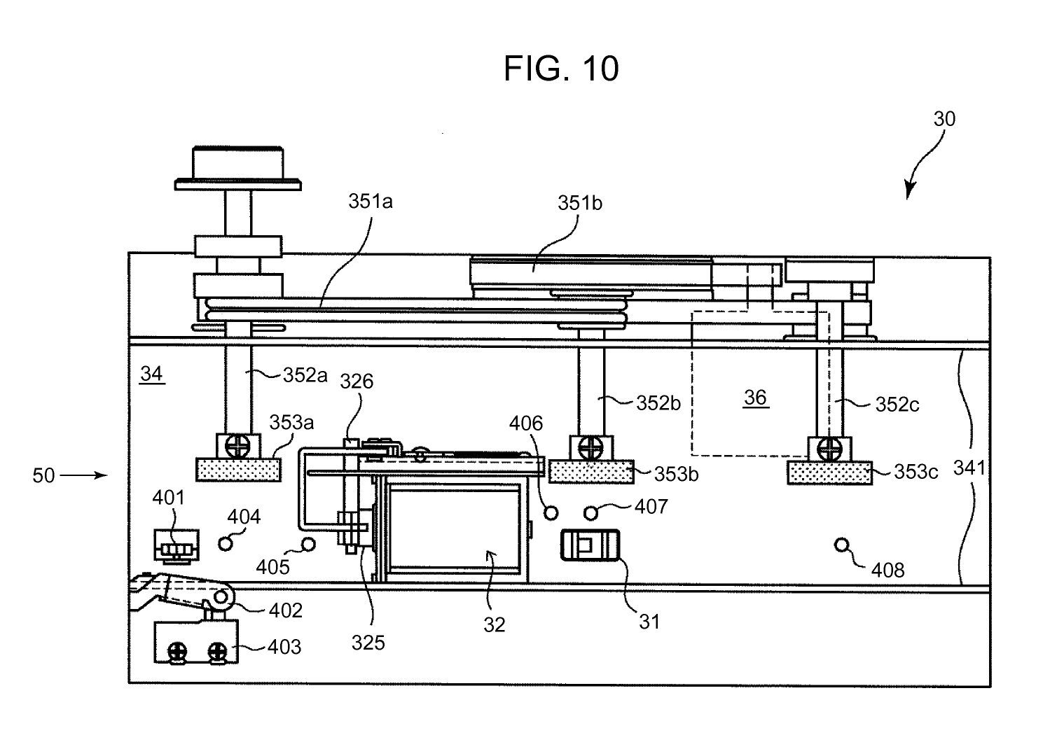

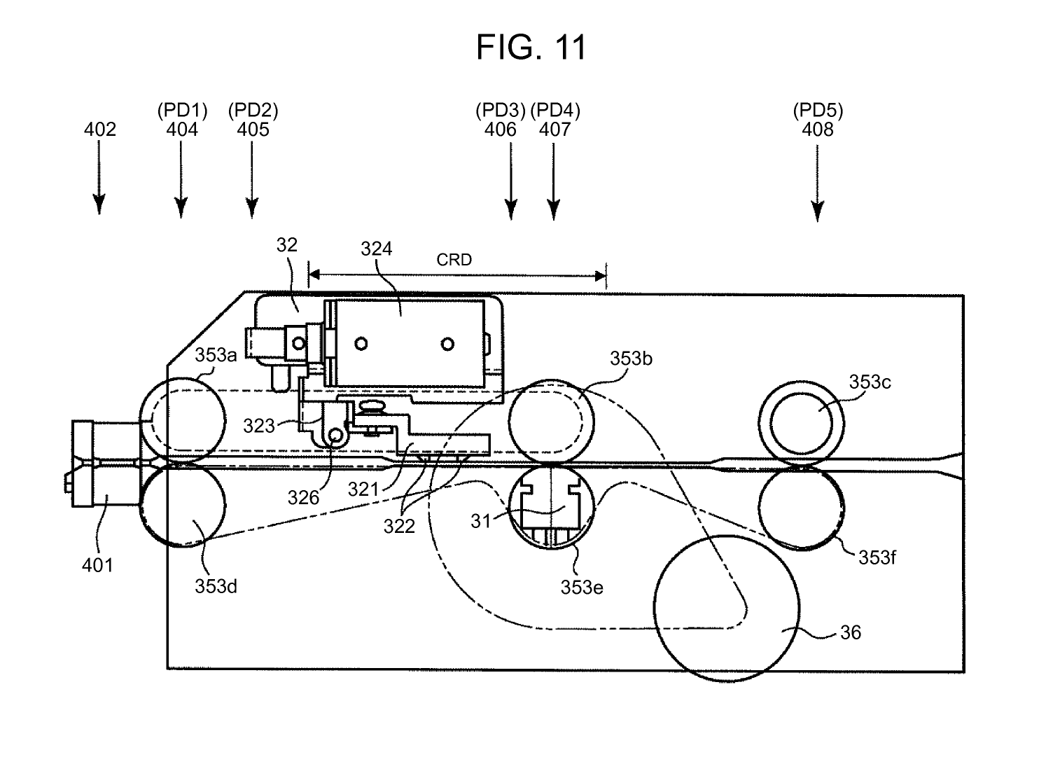

FIG. 10 is a sectional plan view briefly showing a structure of the card reader 30 according to the embodiment of the present invention. FIG. 11 is a longitudinal sectional view briefly showing a structure of the card reader 30 according to the embodiment of the present invention. Incidentally, each arrow in FIG. 11 corresponds to a position having a corresponding reference numeral in FIG. 10.

In FIG. 10, the card reader 30 according to the embodiment of the present invention has the card insertion slot 50 that takes the card CRD, to be inserted in the card reader 30, into the card transfer path 34. Moreover, the card reader 30 includes; the magnetic head for card detection (pre-head) (PH) 401 for transmitting a signal that works as a cue (trigger) for activating the motor 36, the lever 402 protruding from a card transfer path side-plate 341 into the card transfer path 34, and a micro-switch (SW) 403 for detecting a mechanical move of the lever 402. If it is judged in the card transfer control for the card transfer path 34 that a normal transfer is not done in the card medium transfer so as to have an abnormal transfer (jam), the supply control of a write current is carried out for the pre-head 401 (the magnetic head for card detection) at the time of ejecting the card CRD from the card insertion slot 50.

The card reader 30 includes the photo sensors 404 through 408 (PD1 through PD5) placed so as to face photo diodes (not illustrated) for the purpose of detecting a presence/absence, a position, a card length, and the like, of the card CRD existing in the card transfer path 34. The group of detection sensors 40 is composed of the pre-head 401, the lever 402, the micro-switch 403, and the photo sensors 404 through 408. Then, in the card reader 30, the magnetic head 31 for recording and reproducing magnetic information (magnetic data) to/from the card CRD is placed at a position closer to the photo sensors 406 and 407 almost at a central portion in a longitudinal direction of the card transfer path 34. The card reader 30 is so structured as to have the drive motor 36 (inside a dot-line frame shown in the figure) for turning the drive rollers 353d through 353f (refer to FIG. 11) by the intermediary of transmission belts 351a and 351b and drive shafts, forming the card transfer unit 35, and other various mechanical components as well as electrical components (not illustrated).

If the card CRD inserted from the card insertion slot 50 is taken in, the pre-head 401 detects the card being taken in as a fact, and transmits a signal, which works as a cue for activating the drive motor 36, to the CPU 41. Then, the CPU 41 having received the signal transmits an activating signal to the drive motor 36 so that the card CRD inserted is drawn in (for transfer). Subsequently, the card CRD inserted is transferred toward a rear portion of the card transfer path 34 (toward a right-hand side in FIG. 10) by the drive rollers 353d through 353f forming the card transfer unit 35.

The lever 402 and the micro-switch 403 are an example of a “card position detecting sensor” for detecting a position of the card CRD inserted, and they work as a card-insertion detecting switch. When the card CRD inserted from the card insertion slot 50 is taken in, the lever 402 partially protruding into the card transfer path 34 has contact with the card CRD inserted. Then, taking a displacement of the lever 402 downward in FIG. 10 as a cue, the micro-switch 403 detects a mechanical move of the lever 402. At the time, the micro-switch 403 transmits a detection signal notifying of having detected the mechanical move of the lever 402, to the CPU 41; and meanwhile, the CPU 41 senses (recognizes) a presence of the card CRD inserted, on the basis of the detection signal. Incidentally, the lever 402 and the micro-switch 403 can also detect a length of the card CRD, and the like.

Each of the photo sensors 404 through 408 is an optical sensor composed of a combination of a light emitting element and a light receiving element. In the present embodiment, at the time when the card CRD passes between the light emitting element and the light receiving element (namely, through the card transfer path 34), a magnetic stripe ‘mp’ formed on a surface of the card intercepts light from the light emitting element in such a way that a presence of the card CRD can be detected. Incidentally, although magnetic sensors and ultrasonic sensors may be applicable to the photo-sensors 404 through 408, a sensitivity of the former is easily influenced by a magnetic environmental condition of a surrounding area, and a sensitivity of the latter is easily influenced by an ambient temperature and humidity. Therefore, it is preferable to use optical sensors that are not influenced by those conditions. Moreover, an infrared sensor may be used as a detection sensor. Incidentally, the photo-sensors 404 through 408 function as an example of “card position detecting sensors” for detecting a position of the card CRD inserted. Then, only the photo-sensors 404 through 408 may be an example of “card position detecting sensors.”

The IC contact block structural unit 32 works according to control of the CPU 41 in the case where an inserted card is an IC card. The IC contact block structural unit 32 has an IC contact point 322 that can contact with/come in contact with a metal terminal (external terminal) on a surface of the IC card, along the card transfer path 34; and then electronic data is read out and written in when the IC contact point 322 and the metal terminal contact with/come in contact with each other. Meanwhile, the magnetic head 31 placed in the card transfer path 34 operates at the time when a card inserted is a magnetic card, and the magnetic head 31 reads and writes magnetic data by contacting with and sliding on a magnetic stripe ‘mp’ on a surface of the card.

More concretely to describe, in FIG. 11, the IC contact block structural unit 32 installed in the card reader 30 according to the embodiment of the present invention is equipped with a contact block 321 that contacts/comes in contact with the external terminal on the surface of the inserted card CRD (IC card) in order to send and receive information. The IC contact block structural unit 32 includes; the IC contact point 322 placed in the contact block 321 for contacting with/coming in contact with the external terminal, a swinging arm 323 for having the IC contact point 322 contact with/depart from the external terminal, and a drive source (actuator) 324 that operates to swing the swinging arm 323 around a shaft 326 as a center.

The drive source 324 operates the swinging arm 323 by reciprocating a plunger 325, connected to the swinging arm 323, on a straight line. Concretely to describe, the plunger 325 is bias-pressed with a coil spring in a direction for protruding. When a solenoid installed in the drive source 324 is not energized, the plunger 325 works to detach the contact block 321 from an inserted card; and meanwhile, when the solenoid installed in the drive source 324 is energized, the plunger 325 works to move the contact block 321 close to the inserted card by way of swinging the swinging arm 323 around the shaft 326 as a center.

The IC contact point 322 placed in the contact block 321a is configured with two lines of wedge-shaped spring placed in accordance with IC card standards; and laid out in a direction perpendicular to a moving direction of the card CRD inserted; and formed of a material that can bend at the time of contacting with/coming in contact with the card CRD inserted. In the meantime, one end of the IC contact point 322 is soldered to a control circuit board placed in the IC contact block structural unit 32 so as to be electrically connected with the control circuit board. This configuration makes it possible to read out (reproduce) electronic data stored in the card CRD inserted (IC card), and also to write (record) new electronic data into the card CRD inserted (IC card).

The magnetic head 31 includes at least a couple of magnetic cores that are placed face to face across a magnetic gap (gap spacer); and in the meantime, a reproducing coil is wound on one magnetic core, and a recording coil is wound on the other magnetic core; and then the magnetic head 31 moves while the head part is sliding on and contacting with the card CRD inserted. This configuration makes it possible for the magnetic head 31 to read out (reproduce) magnetic information (magnetic data) stored in the card CRD inserted, and also to write (record) new magnetic data into the card CRD inserted. The magnetic head 31 has a similar configuration as the pre-head 401 shown in FIG. 5.

Incidentally in FIG. 11, the drive rollers 353d through 353f rotary-driven by the drive motor 36 are paired with driven rollers 353a through 353c in order to pinch the card CRD inserted between them. In other words, the driven rollers 353a through 353c are individually bias-pressed against the drive rollers 353d through 353f. Concretely to describe, each of the driven rollers 353a through 353c is bias-pressed against each of the drive rollers 353d through 353f from an upper side of the card transfer path 34, in such a way as to be able to come in contact with an upper surface of the card CRD inserted.

Incidentally as a general rule, magnetic information (magnetic data) that the magnetic head 31 reads out or written in is recorded in the magnetic stripe ‘mp’ placed by printing and the like, on the surface of the card CRD inserted, and therefore the magnetic stripe ‘mp’ and the magnetic head 31 are positioned face to face each other in the card transfer path 34. Moreover in the card reader 30 according to the present embodiment, as shown in FIG. 10, the photo sensors 404, 405, and 408 are placed in the same straight line with the magnetic head 31 in a card transfer direction. Accordingly, this arrangement allows the photo sensors 404, 405, and 408 to be placed at a position where the magnetic stripe ‘mp’ passes through in the card transfer path 34. Thus, even in the case where, for example, a transparent card CRD not according to the standards is inserted into the card reader 30, basically a position of the card CRD can be detected, because the magnetic stripe ‘mp’ is formed on a surface of the card and the photo sensors 404, 405, and 408 detect the magnetic stripe ‘mp.’

Furthermore, as downward arrows show in FIG. 11; among the lever 402 and the photo-sensors 404 through 408 referred to as the “card position detecting sensors”, the photo-sensors 404 and 405 are located at a side of the card insertion slot 50, through which the card CRD is inserted, with reference to a position of the magnetic head 31. On the other hand, with reference to the position of the magnetic head 31, the photo-sensor 408 is located at a downstream side of the magnetic head 31 in the transfer direction (a right-hand side in FIG. 11). Thus, when a card CRD, even including a transparent card not according to the standards, is inserted into the card reader 30, a position of the card CRD can appropriately be detected.

In the card reader 30 according to the present embodiment, provided with an above-described configuration, it is on the premise at first that magnetic information is reproduced or recorded by the magnetic head 31, at the magnetic stripe ‘mp’ on the card CRD inserted from the card insertion slot 50. Then, the card reader 30 transfers the card CRD inserted, in the card transfer path 34, by use of the drive rollers 353d through 353f driven by the drive motor 36; and detects a position of the card CRD inserted in order to control the transfer operation, on the basis of a detection signal from the plurality of photo-sensors 404 through 408 provided in the card transfer path 34.

In the present embodiment, the photo-sensors 404 through 408 include; the photo-sensors 404, 405, and 408 that are located at positions where the magnetic stripe ‘mp’ of the card CRD passes through, and the photo-sensors 406 and 407 placed in the vicinity of the magnetic head 31. Incidentally, in the present embodiment, a configuration can be established in such a way; that the card CRD inserted is judged to be a normal card by using a detection signal of, for example, one of the magnetic head 31 and either of the photo-sensors 406 and 407 placed in the vicinity of the magnetic head 31, and then processing continues. In this case, if the card CRD inserted is judged to be a normal card, the card reader 30 reads out magnetic data stored in the card CRD, and writes new magnetic information into the card CRD, by means of having the magnetic head 31 contact with and slide on the magnetic stripe ‘mp’ on the surface of the card CRD inserted. Meanwhile, if the card CRD inserted is an IC card, the card reader 30 reads out electronic data stored in the card CRD, and writes new electronic data into the card CRD by means of having the IC contact point 322 contact with/come in contact with the metal terminal (external terminal) on the surface of the card CRD.

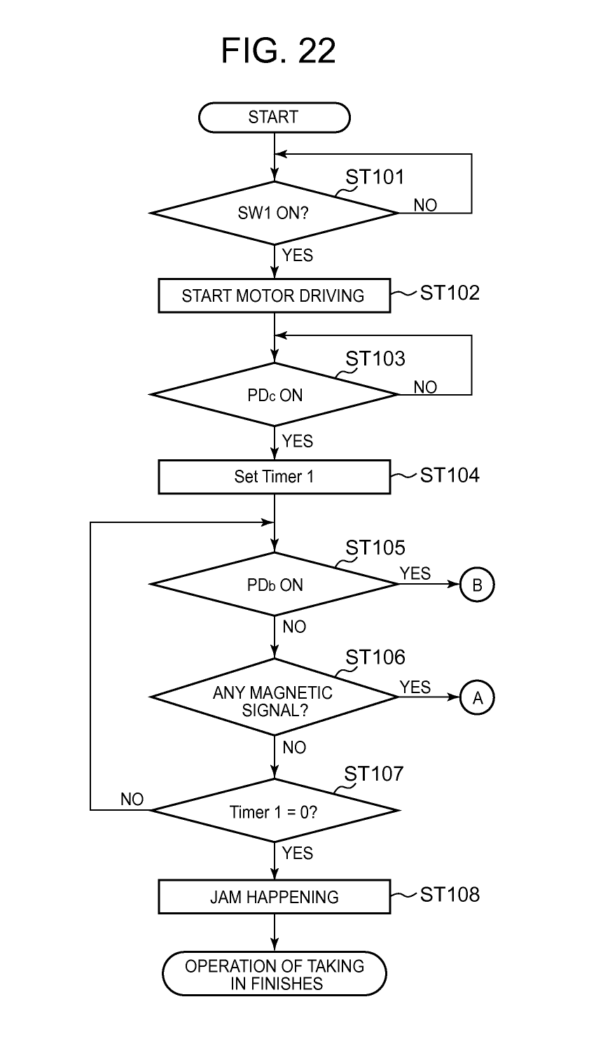

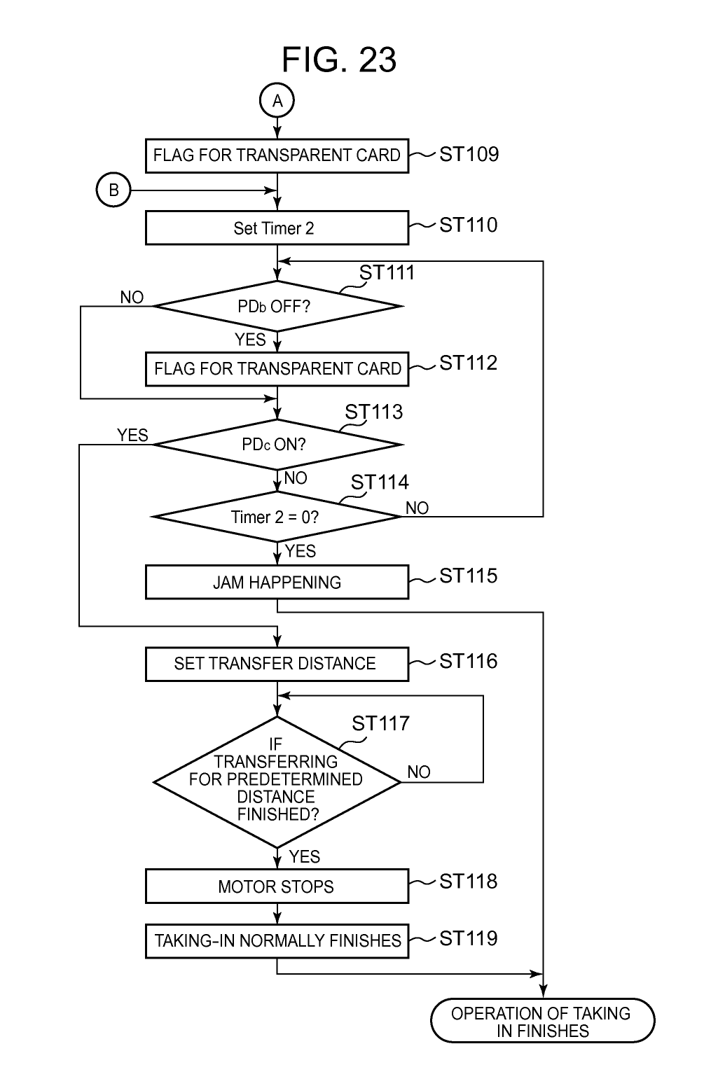

At the time of taking in the card CRD inserted, the card reader 30 according to the present embodiment makes a judgment on whether the card is a transparent card CRD not according to the standards, including a card that is transparent in a patchy fashion, or a normal card. Then, the card reader 30 holds information of the judgment as it is, until a next operation of taking in a card gets started; and keeps algorithms for internal operation separate, in accordance with the judgment result, the internal operation including a card transfer operation in the meantime. Accordingly, a regular algorithm is carried out for a normal card, and on the other hand, later-mentioned processing for a transparent card not according to the standards is carried out in the case of a transparent card not according to the standards (refer to flowcharts of FIG. 22 and FIG. 23 described later), so that even though a transparent card not according to the standards is inserted, the card reader 30 can carry out operation without any problem (continue processing).

Incidentally, while the magnetic head 31 is detecting a signal from a magnetic surface of the card CRD in a method for judging characteristics of the card CRD at the time of taking in the card, the card CRD exists in the vicinity of a head part of the magnetic head 31. Therefore, the magnetic head 31 can be used not only as a means of taking in a magnetic signal but also as a sensor for judging a presence of a card.

(Supply Control of Write Current to Magnetic Head, as Anti-Phishing Countermeasure)

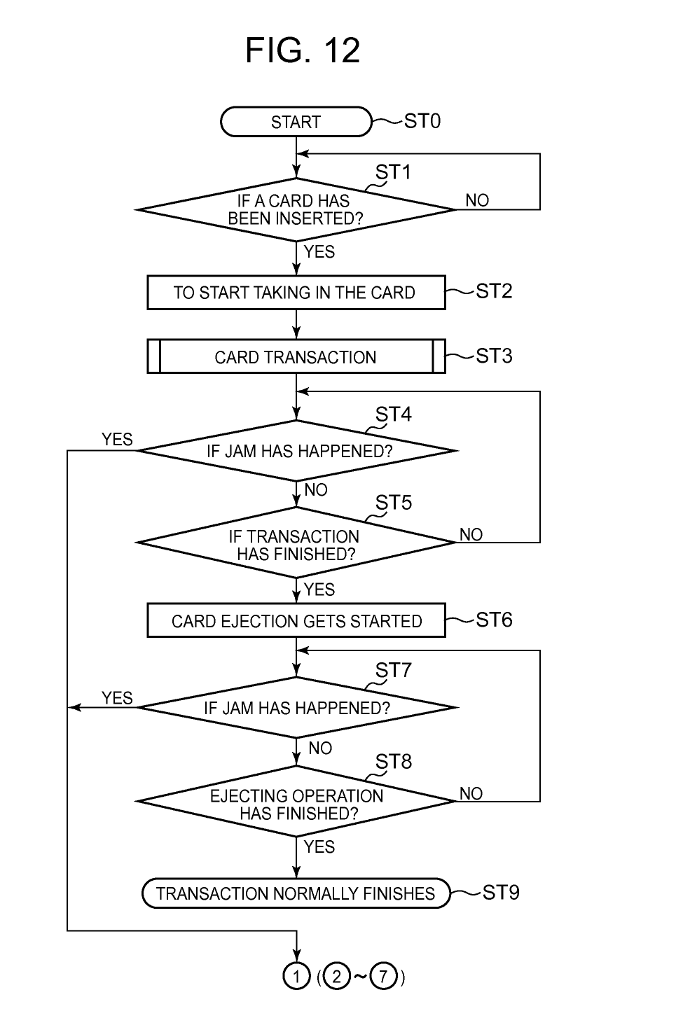

Concrete processing of a supply control of a write current to a magnetic head as an anti-phishing countermeasure in the present embodiment is explained next, with reference to flowcharts of FIG. 12 through FIG. 19. In this section, processing of a supply control of a write current to the magnetic head as an anti-phishing countermeasure is explained with reference to processes of a first example through a seventh example.

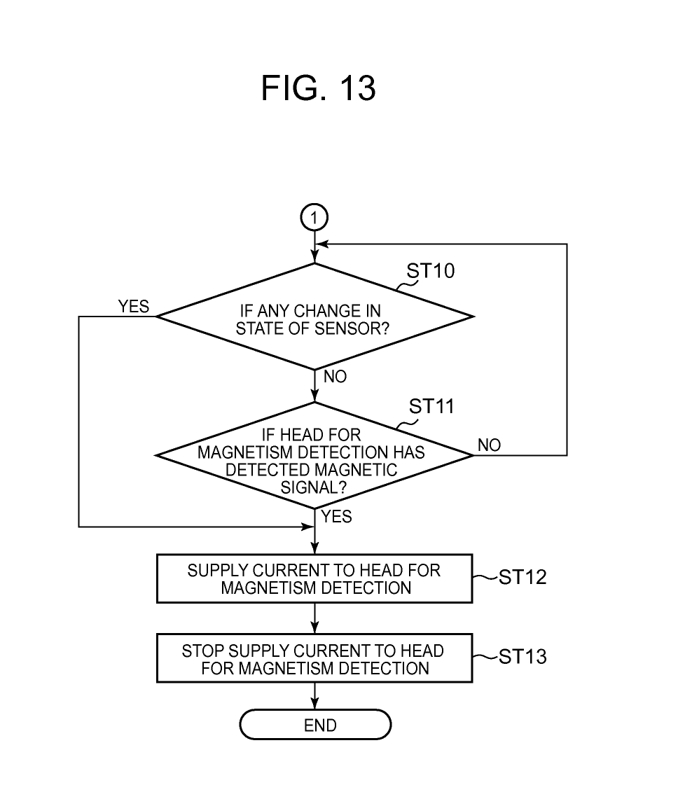

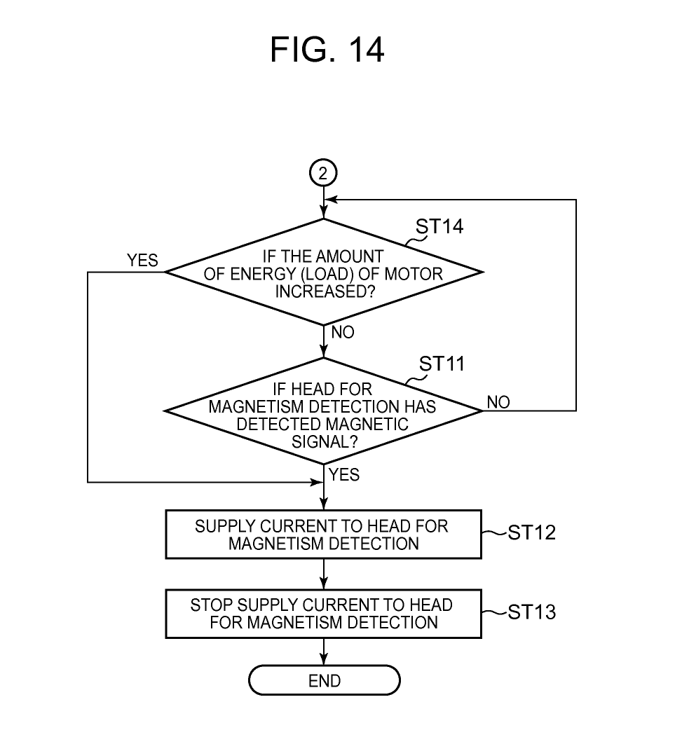

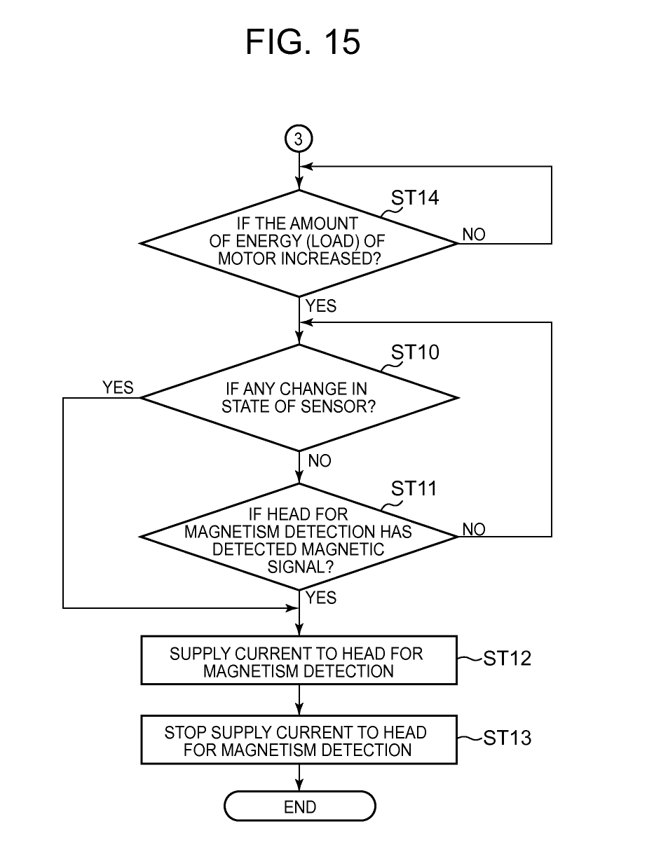

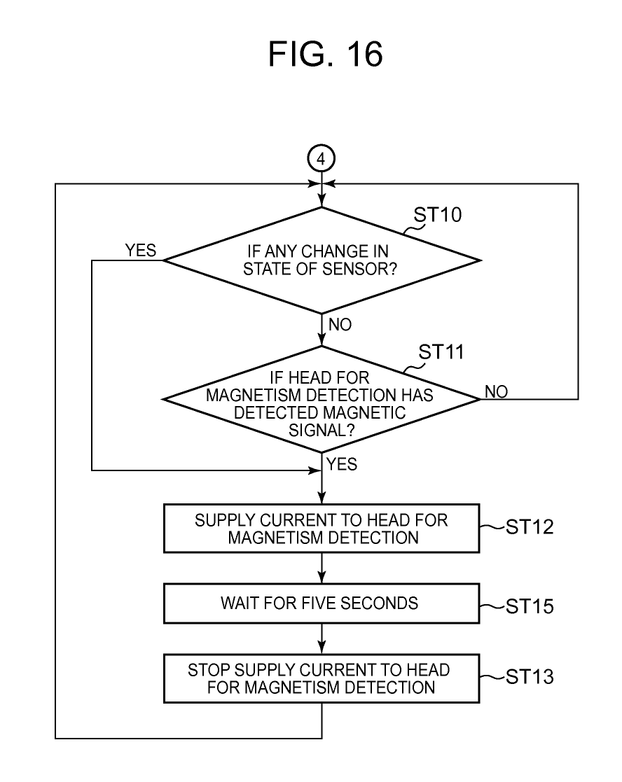

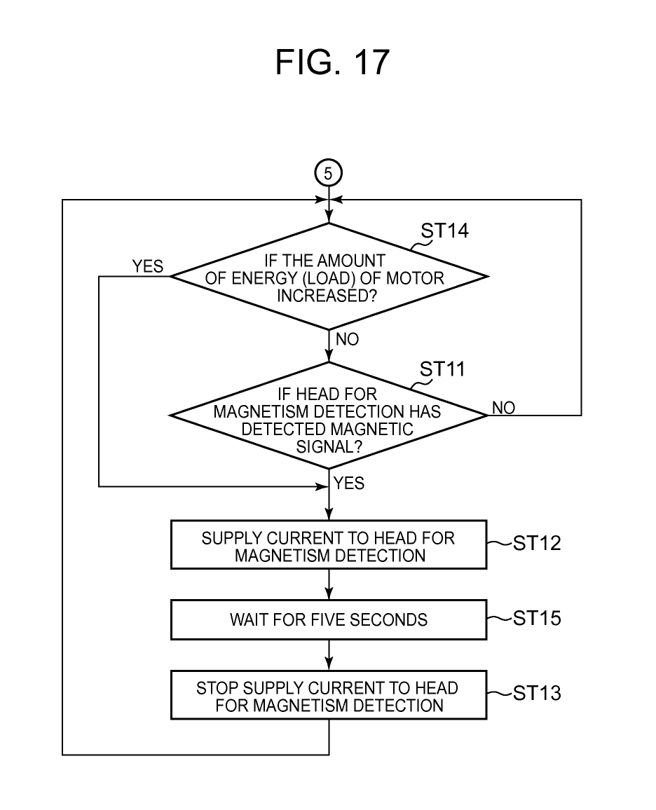

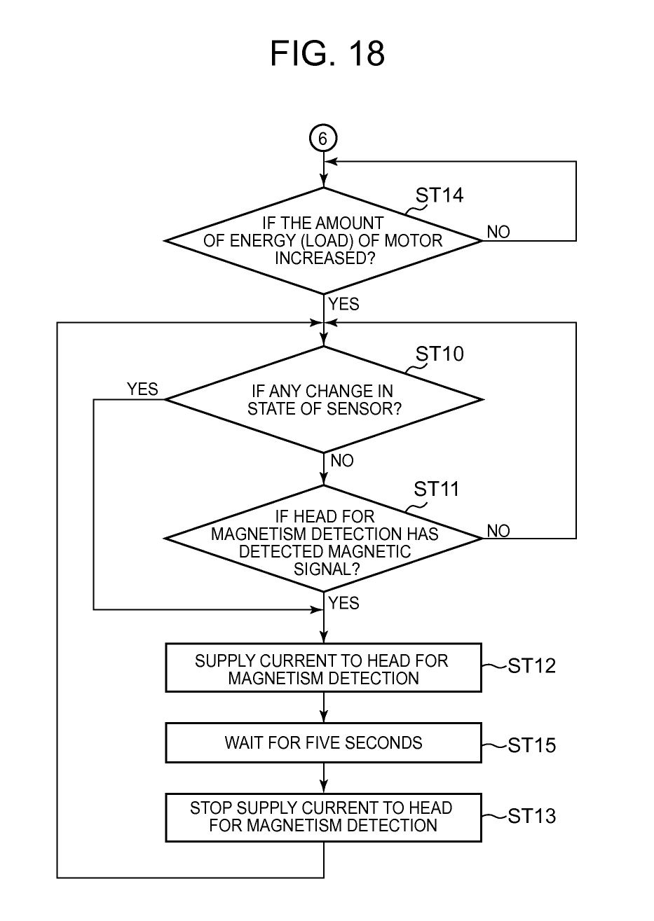

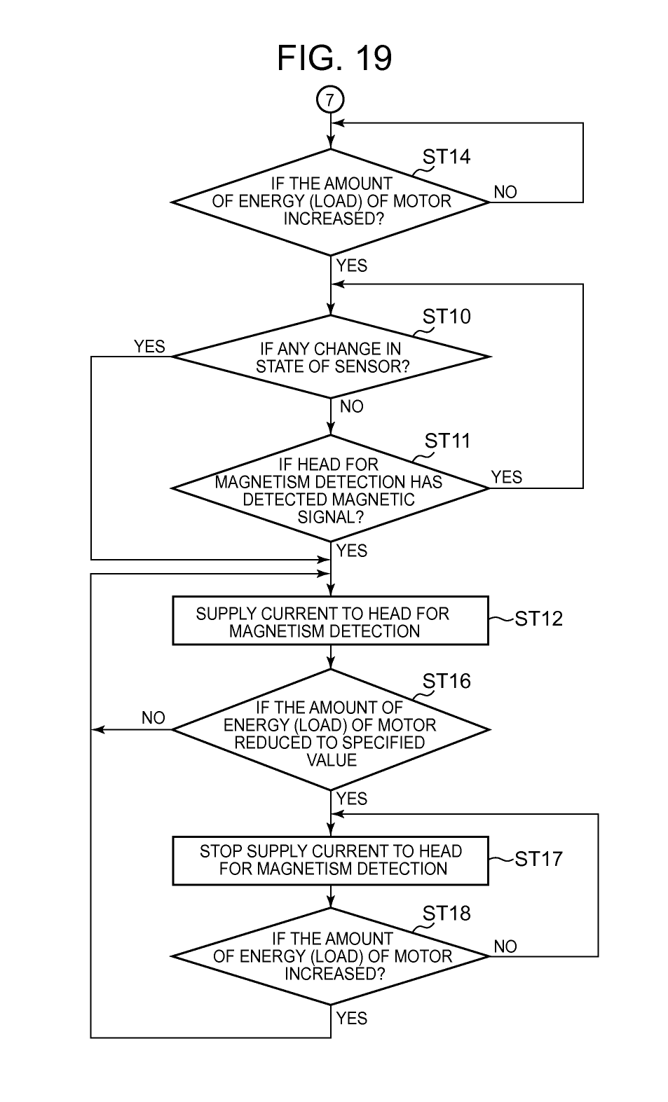

FIG. 12 is a flowchart for explaining a process from a card insertion until an end of transaction, including a presence of an abnormal transfer operation (jam), in the card reader according to the present embodiment. FIG. 13 is a flowchart for explaining a first example of a supply control process of a write current to the magnetic head, as an anti-phishing countermeasure, in the card reader according to the present embodiment. FIG. 14 is another flowchart for explaining a second example of a supply control process of a write current to the magnetic head, as an anti-phishing countermeasure, in the card reader according to the present embodiment. FIG. 15 is another flowchart for explaining a third example of a supply control process of a write current to the magnetic head, as an anti-phishing countermeasure, in the card reader according to the present embodiment. FIG. 16 is another flowchart for explaining a fourth example of a supply control process of a write current to the magnetic head, as an anti-phishing countermeasure, in the card reader according to the present embodiment. FIG. 17 is another flowchart for explaining a fifth example of a supply control process of a write current to the magnetic head, as an anti-phishing countermeasure, in the card reader according to the present embodiment. FIG. 18 is another flowchart for explaining a sixth example of a supply control process of a write current to the magnetic head, as an anti-phishing countermeasure, in the card reader according to the present embodiment. FIG. 19 is another flowchart for explaining a seventh example of a supply control process of a write current to the magnetic head, as an anti-phishing countermeasure, in the card reader according to the present embodiment.

At first, by way of a judgment on whether or not a switch SW1 (the lever 402) and the like has been turned on, the CPU 41 of the card reader 30 judges whether or not a customer has inserted a card CRD (Step ST0 and Step ST1). Incidentally, a detection of an insertion of the card CRD is dependent on an operation mode that a user can select; and usually a judgment is made under either a condition that an insertion detection switch has detected, or another condition that both the insertion detection switch and the pre-head 401 for magnetic detection have detected.

If the CPU 41 judges that the card CRD has been inserted, the drive motor 36 is drive-controlled so as to activate the transfer rollers (drive rollers) 353d through 353f and to start taking in the card (Step ST2). Then, the card CRD is further inserted into a rear portion, and the card CRD is transferred to an installation position of the magnetic head 31 according to a detection result of a photo-sensor as a detection sensor, and a so-called card transaction that includes reading and writing magnetic information is carried out (Step ST3). Next, it is judged whether or not an abnormal transfer operation of the card, i.e. a card jam, has happened (Step ST4).

If it is judged at Step ST4 that no jam has happened (Step ST4: No), then it is judged whether or not the transaction has finished (Step ST5). If it is judged at Step ST5 that the transaction has finished (Step ST5: Yes), an ejecting operation of the card CRD gets started (Step ST6). Then, it is judged whether or not an abnormal transfer operation of the card, i.e. a card jam, has happened in the ejecting operation (Step ST7). If it is judged at Step ST7 that no jam has happened (Step ST7: No), it is judged whether or not the ejecting operation has finished (Step ST8). If it is judged at Step ST8 that the ejecting operation has finished (Step ST8: Yes), the transaction normally finishes (Step ST9).

Incidentally, although details are not described in order to simplify the flowchart, a step leading to a conclusion of “a jam has happened” includes several times of retrying transfer operation, in the judgment on whether or not a jam has happened. When the transfer operation cannot be carried out even after retrying the transfer operation, it is judged that there exists a state of “a jam has happened.”

On the other hand, if it is judged at Step ST4 or Step ST7 that a jam has happened (Step ST4: Yes, or Step ST7: Yes), operation proceeds to one of the supply control processes of a write current to the magnetic head, as an anti-phishing countermeasure, shown in FIG. 13 through FIG. 19. In the explanation below, the same step number ‘ST’ is given to a step of the same procedure, in order to facilitate understanding.

(First Example of Supply Control Process of Write Current to Magnetic Head)

At first, the first example of a supply control process of a write current to the magnetic head, as an anti-phishing countermeasure, is explained in relation to FIG. 13. This is a case where the CPU 41 basically judges it to be an abnormal transfer (jam), for example, as shown in FIG. 7A. It is judged whether or not, for example, the photo-sensor located at the side of the card insertion slot 50 has detected the card CRD (Step ST0). For example, in an example shown in FIG. 7B, it is judged whether or not, the photo-sensor 404 has detected the card CRD. If it is judged at Step ST10 that no change is observed in a state of the photo-sensor 404 and the card CRD is not detected (Step ST10: No), next the card CRD is transferred as shown in FIG. 7C, in a direction for ejection to the side of the card insertion slot 50, and then it is judged whether or not the pre-head 401 has detected a magnetic signal of the magnetic stripe ‘mp’ that is a magnetic record carrier (Step ST11). At this time, if it is judged that a change is observed in the state of the photo-sensor 404 at Step ST10 and the card CRD has been detected (Step ST10: Yes), or if it is judged that a magnetic signal has been detected at Step ST11 (Step ST11: Yes), the pre-head 401 being a head for magnetism detection is supplied with a write current so as to get energized (Step ST12). Subsequently, as shown in FIG. 7D and FIG. 7E, the card CRD is further ejected to the side of the card insertion slot 50, and accordingly the magnetic information recorded in the magnetic stripe ‘mp’ of the card CRD is deleted. Then, the supply of the write current to the pre-head 401 gets stopped (Step ST13).

In this case example, when the card CRD is transferred in the direction for ejection to the side of the card insertion slot 50, and the pre-head 401 detects a magnetic signal of the magnetic stripe ‘mp’ that is a magnetic record carrier, it gets started to supply a write current to the pre-head 401. Accordingly, it becomes possible to supply an electric current only in a time period that really needs an electric power, so that it becomes possible to aim at reducing power consumption.

Moreover, it is judged that a change is observed in the state of the photo-sensor 404 at Step ST10 and the card CRD has been detected (Step ST10: Yes instead of No). A configuration can be established in such a way; that next the card CRD is transferred as shown in FIG. 7C, in a direction for ejection to the side of the card insertion slot 50, and then it is judged whether or not the pre-head 401 has detected a magnetic signal of the magnetic stripe ‘mp’ that is a magnetic record carrier (Step ST11). In this case as well, it becomes possible to supply an electric current only in a time period that really needs an electric power, so that it becomes possible to aim at reducing power consumption.

(Second Example of Supply Control Process of Write Current to Magnetic Head)

Next, the second example of a supply control process of a write current to the magnetic head, as an anti-phishing countermeasure, is explained in relation to FIG. 14. A difference owned by the second example, being different from the first example described above, is a point that; as a trigger for starting a supply control of a write current, a judgment is made at Step ST14 on whether or not the amount of energy (load) of the motor increases, instead of applying a detection result by the detection sensor at Step ST10 shown in FIG. 13. Namely in the second example, after the CPU 41 judges it to be an abnormal transfer (jam), a comparison is made at Step ST14 between the first energy amount obtained by measuring the amount of energy of the motor on the basis of the detection result of the encoder 361 as the detection unit and the second energy amount of the motor, stored in the storage unit, for example, under conditions where the detection sensor is not sensing the card medium (in the situation shown in FIG. 7A). Then, in the case where it is judged that the first energy amount measured has not become greater than the second energy amount that has been stored, operation proceeds to a step of magnetic signal detection & judgment at Step ST11. On the other hand, if it is judged at Step ST14 that the first energy amount measured has become greater than the second energy amount that has been stored (Step ST14: Yes), operation proceeds to a step of a start of supplying a write current at Step ST12.

(Third Example of Supply Control Process of Write Current to Magnetic Head)

Next, the third example of a supply control process of a write current to the magnetic head, as an anti-phishing countermeasure, is explained in relation to FIG. 15. A difference owned by the third example, being different from the first example described above, is a point that; as a trigger for starting a supply control of a write current, a judgment is made at Step ST14 on whether or not the amount of energy (load) of the motor increases before making a judgment on a detection result by the detection sensor, in addition to applying the detection result by the detection sensor at Step ST10 shown in FIG. 13. This configuration brings in an advantage that power consumption can effectively be controlled.

(Fourth Example of Supply Control Process of Write Current to Magnetic Head)

Next, the fourth example of a supply control process of a write current to the magnetic head, as an anti-phishing countermeasure, is explained in relation to FIG. 16. A difference owned by the fourth example, being different from the first example described above, is as described below.

In the fourth example, a configuration is established in such a way as to carry out an intermittent current-supply operation as Step ST15, for example, so as to supply a write current to the pre-head 401 for a predetermined time, e.g., five seconds, and then to subsequently stop supplying the write current, between a step of supplying a write current at Step ST12 and a step to stop supplying the write current at Step ST13. Then, in the fourth example, the configuration is established in such a way as to return to an operation of Step ST10 after the step to stop supplying the write current at Step ST13, and repeat the following steps. In other words, this example is performed as an infinite loop. When an abnormal condition happens, a service person is to be called. Therefore, no loophole is provided for getting out of this loop under normal conditions, and the state continues infinitely and can be reset only by resetting the power supply. By adopting such an intermittent current-supply operation, it is possible to aim at further reducing power consumption.

(Fifth Example of Supply Control Process of Write Current to Magnetic Head)

Next, the fifth example of a supply control process of a write current to the magnetic head, as an anti-phishing countermeasure, is explained in relation to FIG. 17. A difference owned by the fifth example, being different from the fourth example described above, is a point that; as a trigger for starting a supply control of a write current, a judgment is made at Step ST14 on whether or not the amount of energy (load) of the motor increases, instead of applying a detection result by the detection sensor at Step ST10 shown in FIG. 16. Namely in the second example, after the CPU 41 judges it to be an abnormal transfer (jam), a comparison is made at Step ST14 between the first energy amount obtained by measuring the amount of energy of the motor on the basis of the detection result of the encoder 361 as the detection unit and the second energy amount of the motor, stored in the storage unit, for example, under conditions where the detection sensor is not sensing the card medium (in the situation shown in FIG. 7A). Then, in the case where it is judged that the first energy amount measured has not become greater than the second energy amount that has been stored, operation proceeds to a step of magnetic signal detection & judgment at Step ST11. On the other hand, if it is judged at Step ST14 that the first energy amount measured has become greater than the second energy amount that has been stored (Step ST14: Yes), operation proceeds to a step of a start of supplying a write current at Step ST12.

(Sixth Example of Supply Control Process of Write Current to Magnetic Head)

Next, the sixth example of a supply control process of a write current to the magnetic head, as an anti-phishing countermeasure, is explained in relation to FIG. 18. A difference owned by the sixth example, being different from the fourth example described above, is a point that; as a trigger for starting a supply control of a write current, a judgment is made at Step ST14 on whether or not the amount of energy (load) of the motor increases before making a judgment on a detection result by the detection sensor, in addition to applying the detection result by the detection sensor at Step ST10 shown in FIG. 16. This configuration brings in an advantage that power consumption can effectively be controlled.

(Seventh Example of Supply Control Process of Write Current to Magnetic Head)

Next, the seventh example of a supply control process of a write current to the magnetic head, as an anti-phishing countermeasure, is explained in relation to FIG. 19. A difference owned by the seventh example, being different from the sixth example described above, is as described below. In this example, steps of Step ST16, Step ST17, and Step ST18 are provided after the step of supplying a write current at Step ST12; and then after a positive judgment at Step ST18, operation repeats steps starting from Step ST12 including its following steps. In other words, while the pre-head 401 is being energized after supplying a write current starts at Step ST12, a comparison is made at Step ST16 between the first energy amount obtained by measuring the amount of energy of the motor 36 on the basis of the detection result of the encoder 361 as the detection unit and the second energy amount of the motor, stored in the storage unit. Then, if the measured first energy amount is reduced to the second energy amount being stored (Step ST16: Yes), supplying the write current to the pre-head 401 gets stopped (Step ST17).

Then, after supplying the write current to the pre-head 401 gets stopped, a comparison is made at Step ST18 between the first energy amount obtained by measuring the amount of energy of the motor 36 on the basis of the detection result of the encoder 361 as the detection unit and the second energy amount of the motor, stored in the storage unit. Then, if the measured first energy amount has become greater than the second energy amount being stored (Step ST18: Yes), operation proceeds to processing of Step ST12 in order to resume supplying the write current to the pre-head 401.

It is also possible to configure these steps in such a way as to make a combination of the steps of stopping and resuming the current supply, for example, to repeat these steps. Moreover, it is also possible to execute these steps, independently from the intermittent current-supply operation at predetermined time intervals, as described above; and also possible to combine these steps with the intermittent current-supply operation. Such a configuration brings in an advantage that power consumption can effectively be controlled.

(Regular Operation of Card Reader 30)

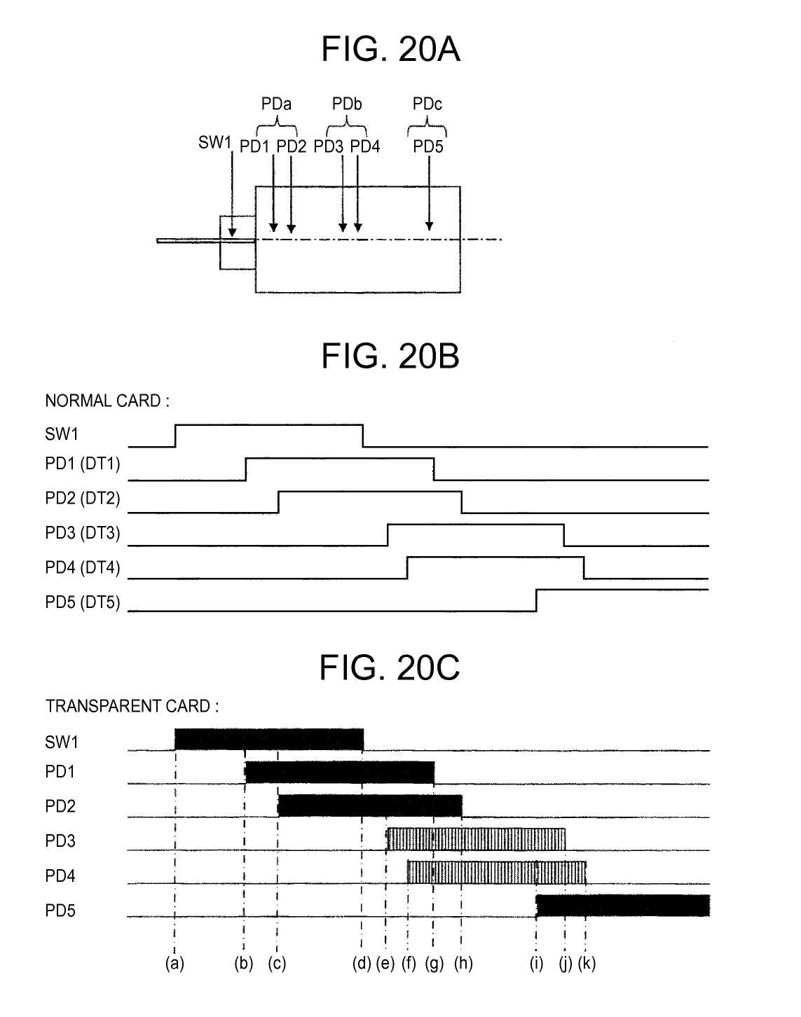

Next, regular operation of the card reader 30 according to the present embodiment is explained in detail, in relation to FIG. 20 through FIG. 23. Explained below is a case where a normal card not being transparent, as well as a transparent card not according to the standards are dealt with.

(Turn-on Timing of Detection Signal of Each Sensor & Actual Transfer Movement of Card CRD)

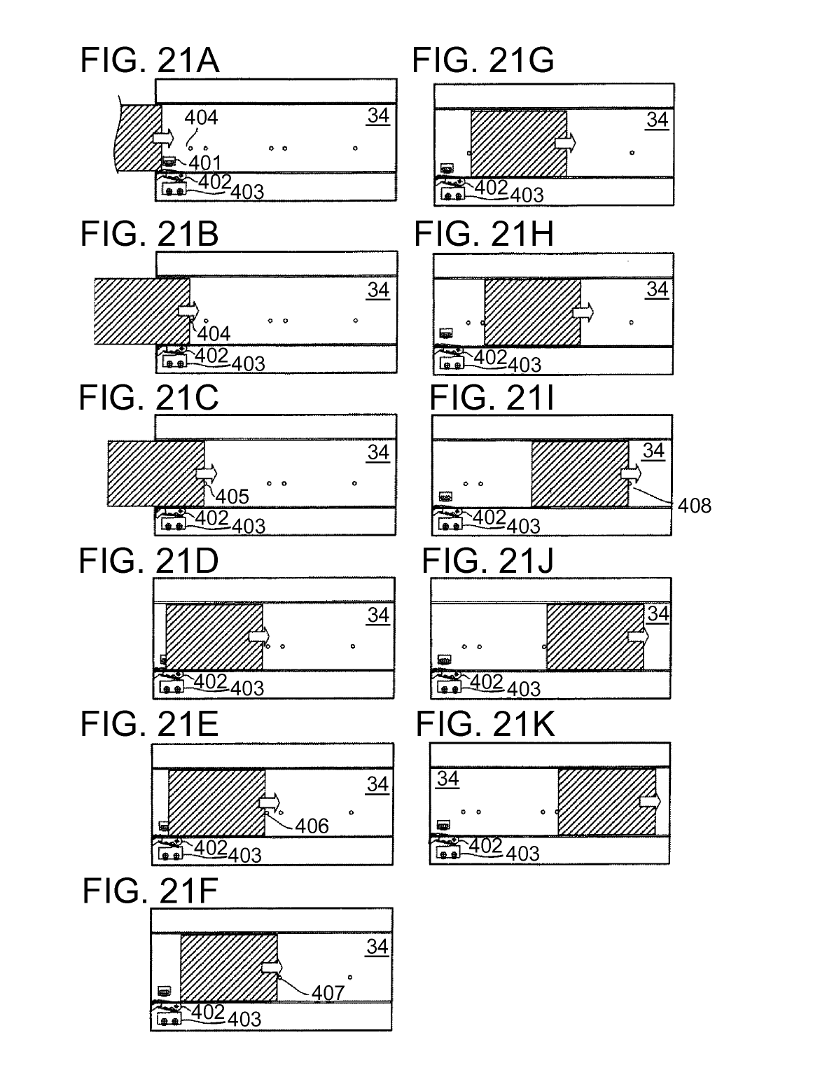

Turn-on timing of a detection signal of each sensor of the group of detection sensors according to the present embodiment and actual transfer movement of the card CRD through the card transfer path 34 are explained below in relation to FIG. 20 and FIG. 21.

FIG. 20 includes diagrams that explain timing when a detection signal of each sensor turns ON. FIG. 21 includes diagrams that show how a card actually moves through a card transfer path. Incidentally, in FIG. 20, the switch SW1 represents a card position detecting sensor for noticing that a customer has inserted the card CRD; and the switch SW1 corresponds to the lever 402 shown in FIG. 10. Moreover, the photo-sensors PD1, PD2, PD3, PD4, and PD5 are all optical sensors; and they correspond to the photo-sensors 404, 405, 406, 407, and 408 shown in FIG. 3, respectively. A layout of these sensors is as shown in FIG. 20A.

A case where a normal card CRD has been inserted, as shown in FIG. 20B, is discussed at first. If the switch SW1 detects the card inserted, the rollers start to turn in a direction for taking the card CRD into the card reader 30 (in a backward direction: toward a right hand side in FIG. 10A); and then a presence of the card CRD inserted is noticed when detection signals DT1 and DT2 of the photo-sensors PD1 and PD2, respectively, turn on (so as to have a higher level in the diagram). Subsequently, when detection signals DT3 and DT4 of the photo-sensors PD3 and PD4 which are located in the vicinity of the magnetic head 31, respectively, turn on (so as to have a higher level in the diagram), it is judged that the card CRD is passing there. Then, at the position, taking (reading) a magnetic signal starts; and after the inserted normal card arrives at a position of the photo-sensor PD5 and subsequently still moves for a specified time period, taking in the card CRD and a transfer of it finishes. In this way, a passing movement of the inserted normal card CRD can be detected by the photo-sensors PD3 and PD4.

On the other hand, in the case of a transparent card not according to the standards; the photo-sensors PD3 and PD4 are located simply in the vicinity of the magnetic head 31, and not located on the magnetic stripe ‘mp’ of the card CRD inserted. Therefore, light passes through a transparent part so that sometimes the card CRD inserted cannot be detected. In such a case, conventionally a usual card reader judges that; a transparent card not according to the standards has been inserted, or the card CRD has been pulled out, and the like; and conventionally the usual card reader executes an error-response step such as a forced ejection.

Therefore, in the case of the card reader 30 according to the present embodiment; if the card CRD cannot be detected even though presumably the card CRD has already been transferred up to a position of the photo-sensors PD3 and PD4, or if it is judged that the card CRD has disappeared from view of the photo-sensors PD3 and PD4 after the photo-sensors PD3 and PD4 once detected the card, the card is judged to be “a transparent card not according to the standards.” Then, if it is judged at the time of taking in the card to be “a transparent card not according to the standards”, control operation is subsequently carried out on the premise that the photo-sensors PD3 and PD4 do not work properly, and it is carried out only to read out magnetic data recorded in the magnetic stripe ‘mp’ on the card CRD. Afterward, by way of driving the drive rollers 353d through 353f, the transparent card not according to the standard is ejected out of the card reader 30.

Incidentally, in the case of a transparent card not according to the standard, any process for which the photo-sensors PD3 and PD4 are indispensable, for example, such a process that needs to understand a precise position of the card CRD, cannot functionally be executed. Concretely to describe, it is impossible to execute a process for writing in new magnetic data with respect to a transparent card not according to the standard, and a process of reading out electronic data stored in the card CRD and writing in new electronic data with respect to the card CRD, and the like if the card CRD inserted is an IC card.

Incidentally, in the case where the card is not “a transparent card not according to the standards”, the card reader 30 carries out operation in the same manner as it does ordinary operation, and therefore an explanation is skipped here. In the meantime, a magnetic signal generated periodically out of the magnetic head 31 means that the card CRD exists in the vicinity of the magnetic head 31. Therefore, if the card CRD does not exist at an installation position of the photo-sensors PD3 and PD4 even though a magnetic signal keeps on coming out of the magnetic head 31, it may be as well to judge the card to be “a transparent card not according to the standards.” Moreover, though a card length of the card CRD inserted is conventionally calculated by using the switch SW1, the photo-sensors PD3 and PD4, and a card transfer distance, the card length of the card CRD may as well be calculated by using arrival timing of the card CRD at the head part of the magnetic head 31 and a card transfer distance, for example, on the basis of the switch SW1 and a magnetic signal from the magnetic head 31.

FIG. 20C and FIG. 21 show each detection signal under conditions where each sensor detects the card CRD inserted. Incidentally, each of items (a) through (k) is in a correspondence relationship between both the diagrams.

In a sequential explanation; the switch SW1 corresponding to the lever 402 turns on at timing represented with (a), the photo-sensor PD1 corresponding to the photo-sensor 404 turns on at timing represented with (b), and the photo-sensor PD2 corresponding to the photo-sensor 405 turns on at timing represented with (c). The switch SW1 turns off at timing represented with (d), the photo-sensor PD3 corresponding to the photo-sensor 406 turns on at timing represented with (e), and PD4 corresponding to the photo-sensor 407 turns on at timing represented with (f). The photo-sensor PD1 turns off at timing represented with (g), the photo-sensor PD2 turns off at timing represented with (h), and PD5 corresponding to the photo-sensor 408 turns on at timing represented with (i). Then, the photo-sensor PD3 turns off at timing represented with (j), and the photo-sensor PD4 turns off at timing represented with (k).

In this explanation, an interval represented with a vertical-striped pattern in FIG. 20C corresponds to an interval in which no response is given to “a transparent card not according to the standards.” Concretely to describe, if a transparent part is placed in an area that is not allowed to have a transparent part according to the standards, sometimes the photo-sensors PD3 and PD4 obtain no detection signal. Then, in the present embodiment, a magnetic signal, obtained from the magnetic head 31 that is located in the same straight line as the photo-sensors PD1, D2 and PD5, is used for detecting a card position; the magnetic signal being turned on and off almost at the same timing as the detection signal from the photo-sensors PD3 and PD4. Therefore, even in the above-mentioned case, a process of recording and reproducing magnetic/electronic data can be continued within an achievable range.

(Operation of Card Reader at the Time of Card Transfer)

Operation of the card reader 30 according to the present embodiment is explained below, wherein an operation in relation to a detection signal of each sensor being focused on in association with a card transfer.

FIG. 22 and FIG. 23 are flowcharts for explaining an operation in relation to a detection signal of each sensor, in association with a card transfer, in the card reader according to the present embodiment.

At first, in order to make a judgment whether or not a card CRD has been inserted by a customer, the CPU 41 of the card reader 30 judges whether or not the switch SW1 (the lever 402) has turned on (Step ST101). At the time when the switch SW1 (the lever 402) turns from OFF to ON (Step ST11: YES, Refer to FIG. 21(a)), the CPU 41 drive-controls the drive motor 36 by using the turning from OFF to ON as a cue (trigger) so as to start operation of the transfer rollers (drive rollers) 353d through 353f (Step ST102). Subsequently, the card CRD is further inserted into a rear portion; and when the photo-sensor PD1 (PDa) turns on (Step ST103: YES, Refer to FIG. 21(b)), a card transfer starts, and meanwhile the CPU 41 sets a timer TM1 not illustrated, for example, for a time period of two seconds (Step ST104).

Incidentally, if once the card transfer starts, it becomes possible to calculate a card transfer distance of the card CRD inserted by using an encoder pulse count ticked by revolutions of the transfer rollers (drive rollers) 353d through 353f. On the other hand; each distance from the switch SW1 to the photo-sensor PD1, from the photo-sensor PD1 to the photo-sensor PD3, and from the photo-sensor PD3 to the photo-sensor PD5 is known from a mechanical view point.

Next, the CPU 41 of the card reader 30 judges whether or not the photo-sensor PD3 (PDb) has turned on (Step ST105). In the case where the photo-sensor PDb does not turn on even if the card CRD is inserted and a detection of a magnet signal coming out of the magnetic head 31 starts (Step ST105: NO & Step ST106: YES), the card CRD is judged to be “a transparent card not according to the standards” (first judgment). Concretely to describe, the CPU 41 sets a “flag for a transparent card not according to the standards” in a memory area such as a RAM and the like (Step ST109 shown in FIG. 13).

In the meantime, if the photo-sensor PDb turns on (Step ST105: YES), any “flag for a transparent card not according to the standards” is not set particularly, and operation proceeds to Step ST110 shown in FIG. 23. On the other hand, if the photo-sensor PDb does not turn on and a detection of a magnet signal coming out of the magnetic head 31 does not start (Step ST105: NO and Step ST106: NO), a judgment is made on whether or not the timer TM1 set for a time period of two seconds, for example, has become zero (Step ST107). If it has already become zero (Step ST107: YES), it is assumed that a jam has happened (Step ST108), the operation of taking in finishes.

Incidentally, with respect to a step after the finish of the operation of taking in by way of Step ST108, various steps are possible. For example, the card CRD may be ejected by force, or may be held inside the card reader 30 until a service person arrives, or may be taken into the higher-level device 20 by way of the card reader 30.

Next, as shown in FIG. 23, a timer TM2 of the CPU 41 of the card reader 30 is set (Step ST110). Then, the CPU 41 judges whether or not the photo-sensor PDb has turned off (Step ST111). If the photo-sensor PDb turns off (Step ST111: YES), a “flag for a transparent card not according to the standards” is set in the memory area such as a RAM and the like (Step ST112). The flag means that the card is a transparent card.

In the meantime, if the photo-sensor PDb turns on (Step ST111: NO), the card CRD is not “a transparent card not according to the standards” and then the card is dealt with as a normal card. Incidentally, for a normal card, an ordinary algorithm is executed; and an explanation on a process (operation) for dealing with such a normal card is skipped here.

Next, it is judged whether or not the photo-sensor PD5 (PDc) turns on (Step ST113) in a time period before the timer TM2 becomes zero (Step ST114). In the case where the photo-sensor PDc does not turn on (Step ST113: NO & Step ST114: YES), it is assumed that there has happened a phenomenon of the card CRD being stopped around a central portion in the device (a so-called jam) (Step ST115), and then the operation of taking in finishes. With respect to a step after the finish of the operation of taking in, the same can be said as described above.

On the other hand, if the photo-sensor PDc turns on before the timer TM2 becomes zero (Step ST113: YES), a transfer distance is set (Step ST116) and the card CRD inserted is transferred for the predetermined distance. Then, if the card CRD inserted has been transferred for the predetermined distance (Step ST117: YES), it is assumed that the card transfer has finished; and the drive motor 36 gets stopped (Step ST118), and the operation of taking in the card finishes (Step ST119).

If “a flag for a transparent card not according to the standards” is set at either step of Step ST109 and Step ST112 described above, operation is carried out as described below. Incidentally, as a definition, “a flag for a transparent card not according to the standards” mentioned here means a card CRD for which a presence of the card can exactly be judged by the photo-sensors PDa and PDc, and meanwhile a presence of the card cannot unfortunately be judged properly by the photo-sensor PDb located in the vicinity of the magnetic head 31 for detecting a magnetic signal. It is assumed that; at least a card transfer control and magnetic signal read-out can be done with respect to the card CRD, and magnetic data is already written in the card CRD. Meanwhile, all ordinary functions are enabled with respect to a normal card that is not a transparent card not according to the standards; and a subsequent control is carried out, separately in accordance with the judgment.

At first, in the case of “a transparent card not according to the standards”, a detection signal from the photo-sensor PDb is unreliable and cannot be used for a subsequent transfer control. For example, when a card CRD existing in a rear portion (a right hand side in FIG. 10) is transferred to a front portion (a left hand side in FIG. 10), the drive rollers 353d through 353f are driven and then the photo-sensor PDb turns on. Subsequently, the photo-sensor PDc turns off, and moreover the photo-sensor PDa turns on, and the photo-sensor PDb turns off. Then, after a transfer for a certain distance, the card CRD stops at a stop position in a front portion (a front side section). Therefore, in order to stop the card CRD at the stop position in a front portion, the photo-sensor PDb needs to work normally.

Therefore, in the card reader 30 according to the present embodiment, a transfer of the card CRD from a rear portion starts, and sometime later the photo-sensor PDa turns on; and meanwhile, the stop position in a front portion is determined with a transfer distance, on the basis of timing of the photo-sensor PDa turning from OFF to ON. Moreover, attention should be paid to a phenomenon as an abnormal situation in which a card CRD gets stopped in the device (in the card reader 30), for example, around a central portion of the device (a so-called jam). A reason is because, in such a situation, a jam happens around the central portion; and subsequently at the time of beginning a restoration work, no sensor reacts on the card CRD. In other words, it would be assumed in the situation that no card CRD exists in the device, so that no further operation can be carried out; and namely, in a situation of no card existing, it becomes possible to take in a next card CRD.

Therefore, if there happens a jam judged to be with a transparent card not according to the standards, it becomes necessary not only to simply carry out retry operation, but also namely to move the card to a position where some sensor can detect the card CRD in the same single step, for example, by driving the rollers in a direction opposite to a normal direction adopted up to the time, and the like.

Nevertheless, if a control by using the photo-sensor PDb is by any means necessary, the control needs to be exclusively carried out, being separate from operation for a transparent card not according to the standards. For example, for a manual card reader that can deal with an IC card of a contact type, the card needs to be moved to a position of the IC contact point, which is specified in a present situation with a transfer distance after a card end passing over the photo-sensor PDb, during a card transfer movement. Unfortunately, in the case of a transparent card for which the photo-sensor PDb does not normally work, such an operation cannot be materialized so that the operation command must be canceled before it is executed (for example, by returning an error code as “inexecutable”). In a similar manner, also in a process of writing in magnetic data, a magnetic data writing start position is specified with a transfer distance after an end of the card CRD passing over the photo-sensor PDb, during a transfer movement of the card CRD; and therefore, the operation command must be canceled before it is executed. In this way, though some commands (directions) must be canceled, other commands (directions) that can be executed are able to normally work out as much as possible. Incidentally, a judgment on a transparent card not according to the standards remains valid until a next card CRD is inserted.

Incidentally, in FIG. 22 and FIG. 23, a transfer control and a gain control described above can be done by using three photo-sensors; namely, either PD1 or PD2, PD3, and PD5.

Next, an explanation is made about the second invention. Incidentally, a detailed explanation that is the same as for the embodiment already described above is skipped here.

An embodiment of the second invention is explained below with reference to the accompanying drawings. In the embodiment described below, an explanation is made by illustrating a card reader (including a card reader/writer) that is configured in such a way that information can be read and written from/to both a magnetic card and an IC card (in such a way as to have an information recording function in addition to an information reproducing function), by example, as a card medium processing device. Incidentally, in the present embodiment, an anti-phishing countermeasure against a fraudulent use of a card is taken as a measure for a magnetic card, as described later. Therefore, in the description below, the explanation is made on the assumption that, in an elementary sense, the card is a magnetic card, excluding an explanation about an IC contact block structural unit. Meanwhile, at least an embodiment of the present invention can be applied to, not only a card reader but also a card scanner, a card printer, and the like as electronic equipment.

FIG. 1 is a block diagram showing a general overview of an information processing system according to an embodiment of the second invention. Incidentally, FIG. 1 is already explained in the above description, and therefore a detailed explanation is skipped here.

An information processing system 10 is so configured as to include a higher-level device (a host unit) 20 as an information processing device, a card reader (an electronic device) 30 as a card medium processing device, and a card (a magnetic card or an IC card) CRD.

(Configuration and Function of Higher-Level Device)

The higher-level device 20 carries out a communication control at an interface with the card reader 30 for obtaining information from the card reader 30 by way of sending and receiving various information, such as receiving a response (a reply) corresponding to transmission of a command, and the like.

If an abnormal transfer, i.e. a so-called jam (jamming operation), happens in the card reader 30; for example, at the time of transferring the card CRD, a normal transfer becomes impossible owing to a phishing scam of a wrongdoer, or the card cannot normally be transferred because of a card form status or a card surface status (a transfer roller slipping because of oil, etc.); the higher-level device 20 receives information of the abnormal transfer and obtains the information. For example, at the time of turning on the power (at start-up), or re-starting by turning on the power after a shutdown of the card reader 30 due to a power failure and the like, the higher-level device 20 receives information of a result of a card searching process to investigate a presence/absence of the card at a side of the card reader 30, to be described later, and obtains the information.

Incidentally, in the present embodiment, “the time of the start-up” includes; the time of turning on power after an installation of the card reader 30, the time of turning on power again after power-off of the card reader 30 due to an unexpected accident such as a power failure, and the time of initializing (which includes resetting) in accordance with a command from the higher-level device 20; and according to the start-up as a cue (trigger), a process of searching a card begins.

FIG. 2 is a diagram that conceptually shows a configuration example of a higher-level device according to the present embodiment. The higher-level device 20 shown in FIG. 2 is so configured basically as to include a CPU 21 as a processing unit, a ROM 22, a RAM 23, a storage unit 24, a display unit 25 for indicating information such as a warning, etc., an operation unit 26 including a keyboard 261 and a mouse 262, and an interface circuit 27 for sending and receiving information to/from the card reader 30. Incidentally, FIG. 1 is already explained in the above description, and therefore a detailed explanation is skipped here.

(General Overview of Signal Processing System of Card Reader)

FIG. 3 is a block diagram showing a configuration example of a card reader as a card medium processing device according to the embodiment of the present invention. FIG. 4 is a diagram that conceptually shows a configuration example around a card insertion slot of the card reader according to the present embodiment. Incidentally, FIG. 3 and FIG. 4 are already explained in the above description, and therefore a detailed explanation is skipped here.

While recognizing a position and the like of the card CRD, detected by using each detection sensor of the group of detection sensors 40, in the card transfer path 34, the CPU 41 carries out; a drive control for the motor 36; recognition processing on a presence/absence of the card CRD; control processing of the card transfer; and a control of read processing and write processing of information (data) from/to the card CRD. The CPU 41 carries out a gating control of the shutter 38, in accordance with a detection result on magnetic information by using the pre-head PH. In the case where the card CRD inserted is an IC card, the CPU 41 carries out an activation control of the IC contact block structural unit 32, and a control of sending/receiving information to/from an IC of the card side through a contact point.

For example, at the time of turning on the power (at start-up), or re-starting by turning on the power after a power-off of the card reader 30 due to a power failure and the like, the CPU 41 carries out a card searching process to investigate a presence (remaining, or being suspended) of the card CRD at a side of the card reader 30. Having received a command, from the higher-level device 20, instructing whether to eject the remaining card CRD or not, wherein the command being received as a response to information transmitted from the side of the card reader 30 that the card CCRD is remaining in the card reader 30 (device), the CPU 41 controls the drive motor 36 and the like in order to execute a step according to the command.

As described above, in the present embodiment, “the time of the start-up” includes; the time of turning on power after an installation of the card reader 30, the time of turning on power again after power-off of the card reader 30 due to an unexpected accident such as a power failure, and the time of initializing (which includes resetting) in accordance with an instruction (command) from the higher-level device 20; and according to the start-up as a cue (trigger), a process of searching a card begins.

The CPU 41 includes an energy amount measurement & judgment unit, which measures the amount of energy at the time when the drive motor 36, driving for a card searching process, gets into a constant-speed state, at start-up, according to an output of the encoder 361 as a detection unit for detecting a turning state (rpm and rotational position) of the motor; and makes a comparison between the measured energy amount and the energy amount of the drive motor 36 at the time of idle running, the latter energy amount being stored in the storage unit; and judges whether or not the card CRD exists in the card reader 30 (device).

In the present embodiment, a DC motor is used as the motor 36, as described above; and in a method applied for controlling a motor speed, the amount of energy to a motor drive system is fed back, on the basis of a period of a pulse signal from the drive motor 36 (an encoder pulse). Incidentally, as the amount of energy to a motor drive system, it is possible to store statistical data under a constant-speed control, excluding an accelerating control (such as, at the time of starting operation, braking control for stop, and changing the speed), in a memory unit 413. Meanwhile, it is possible to become aware of the amount of power at the time of transferring a card, and idle running (a state with no card CRD in the device), in advance. Incidentally, it is possible to quantify “the amount of energy to a motor drive system” in accordance with, for example, a time period of “ON” within a certain time by ON/OFF operation of a motor drive circuit (driver). Alternatively, while controlling the voltage to be applied to the drive motor 36 by way of a D/A (Digital/Analog) converter, a CPU 41 can materialize quantification of the amount of power by using an average of the applied voltage.

As described above, the CPU 41 can become aware of the applied amount of energy by use of a value that is sequentially quantified, as a motor driving state. When the amount of energy in a very short time period is observed so as to compare the amount of energy ‘CENG’ that is applied to the motor 36 being driven at a constant speed, in two cases; i.e., with and without the card CRD existing internally, the amount of energy in the case with the card CRD existing is obviously greater. In addition to the above information, it is also known that, although depending on a form of the card CRD and other conditions, the amount of energy fluctuates within a certain time period in the case where the card CRD exists in the device. Usually, a presence/absence of the card CRD in the card reader 30 is detected by a card detection sensor and the like of the card reader 30. Unfortunately, in recent years, sometimes there appears a card CRD that emphasizes not only its functionality but also design; and then in an extreme case, design is valued so much that design is prioritized even in an area that is not specified according to the standards, and even a presence of such a card CRD cannot frequently be detected by the group of detection sensors 40 described above. Under conditions where it is judged that no card CRD internally exists, the CPU 41 can become aware of the presence of the card CRD in the card reader 30, while driving the motor for a very short time period and detecting the amount of energy to be supplied to the motor drive system under the condition. For a judgment on whether or not the card exists, a comparison is made between the applied amount of energy to the drive motor 36 under conditions where a constant speed seems to be obtained after driving for the very short time period, and the applied amount of energy to the motor, in the case of having no card, obtained by way of past statistics. Then, if the present applied amount of energy is obviously greater, it is judged that the card CRD internally exists.

FIG. 8 is a diagram showing a configuration example of an energy amount measurement & judgment unit according to the present embodiment. FIG. 9 is a diagram showing changes in drive power (load) and speed at an acceleration time and a constant speed time, in a motor drive operation according to the present embodiment of the second invention. In FIG. 9, a curve line ‘A’ shows the change in the power, and in the meantime, a curve line ‘B’ shows the change in the speed as well as the amount of energy according to the speed.

The energy amount measurement & judgment unit 410 shown in FIG. 8 is so configured as to include a measurement unit 411, a judgment unit 412, and the memory unit 413 as a storage unit.

Being arranged on a coaxial position, i.e., on the same axis position as an output shaft 362 of the drive motor 36, there is placed the encoder 361 as a detection unit for detecting a motor turning speed. From the encoder 361, a signal EPL of a turning pulse is sent to the measurement unit 411 of the energy amount measurement & judgment unit 410 of the CPU 41.

The measurement unit 411 measures the amount of energy ‘CENG’ at the time when the drive motor 36 driving for a card searching process gets into a constant-speed state at start-up, according to an output of the encoder 361 as a detection unit for detecting a turning state (rpm and rotational position) of the drive motor 36.

The judgment unit 412 makes a comparison between the amount of energy ‘CENG’ measured by the measurement unit 411 and the amount of energy ‘IENG’ of the drive motor 36 at the time of idle running; the amount of energy ‘IENG’ being stored in the memory unit 413; and then makes a judgment on whether or not the card CRD exists in the card reader 30 (device). If the amount of energy ‘CENG’ measured is greater than the amount of energy ‘IENG’ at the time of idle running, the judgment unit 412 makes a judgment that the card C exists in the card reader 30; and contrarily if the former is smaller than the latter, the judgment unit 412 makes a judgment that the card CRD does not exist in the card reader 30.

The memory unit 413 preliminarily stores (to store memory) the amount of energy ‘IENG’ of the drive motor 36 at the time of idle running when the card transfer path 34 is not transferring the card CRD.

In the present embodiment, the amount of energy ‘CENG’ is represented by “time×current (to be applied to the drive motor 36)”. Concretely to describe with reference to FIG. 9, for example, the amount of energy in a range shown as “MEASURING RANGE” is defined as the amount of energy ‘CENG’. In other words, the amount of energy at the time when a turning speed of the drive motor 36 reaches a regular speed of a constant rpm (constant speed), after spending a predetermined time period from a start-up, is the amount of energy ‘CENG’. In general, the card reader 30 is controlled by the CPU 41 in such a way that the drive motor 36 operates at the regular speed. Thus, at the time of idle running, namely, under the condition that no card CRD is remaining inside the card reader 30, the drive motor 36 maintains the regular speed with the amount of energy ‘CENG’, as a curve with a symbol “B” shows in FIG. 9. On the other hand, if the card CRD is remaining inside the card reader 30, a load is placed on the drive motor 36, and therefore the amount of energy ‘CENG’, as a curve with a symbol “A” shows in FIG. 9 is necessary for the drive motor 36 to maintain the regular speed. Then, a configuration can be made in such a way as to judge whether or not the card CRD exists in the card reader 30 (device), by measuring a difference Δ of the amount of energy ‘CENG’. Therefore, a configuration can be made in such a way as to judge whether or not the card CRD exists in the card reader 30 (device), while the CPU 41 measures the difference Δ of the amount of energy ‘CENG’, by way of comparing a current under the condition of the symbol “B” with a current under the condition of the symbol “A”.

If (or after) it is judged that the drive motor 36 is driven at a start-up to reach a constant speed, and have spent a time period (a very short time period) with which the amount of energy at the constant speed can be measured, the CPU 41 issues an instruction to the driver 37 in order to stop the operation of the drive motor 36. Having judged that the card CRD exists in the card reader 30, and having received a command for ejection from the higher-level device 20, the CPU 41 drive-controls the drive motor 36 by way of the driver 37, in such a way as to eject the card CRD. Moreover, a configuration can also be made in such a way that; having judged that the card CRD exists in the card reader 30, and having received a command (instruction) for issuing an alarm from the higher-level device 20, the CPU 41 issues a warning, such as an alarm, by way of a display unit and an audio processor that are not illustrated.

As described above, in the case of a conventional card reader, it is necessary to drive the drive motor 36 unconditionally in a direction for ejecting the card CRD (for a distance of the ejection) without any command (instruction) from the higher-level device 20, even though it is judged that the card CRD does not exist in the device. On the other hand, according to the present embodiment; for example, when the card CRD being a transparent card internally remains, and it is judged that the card CRD exists in the device, a process can be carried out after waiting for a command (instruction) from the higher-level device 20 (presumably a card may exist in the device, and should the card be ejected or not?).

Furthermore, the card reader 30 is connected to the higher-level device 20 by the intermediary of the interface circuit 42 as well as a communication line, in order to send information of, for example, demodulation data, and information of a result of the card searching process, through which a presence/absence of the card CRD is investigated at start-up at the side of the card reader 30, to the higher-level device 20. As the interface circuit 42, various communication methods such as, RS232C method, Parallel Port method, USB connection method, and the like are adopted, as described above, in order to establish a communication between the higher-level device 20 and the card reader 30.

Described above is a general overview of a configuration and a function of a signal processing system and a driving system in relation to a card transfer operation of the card reader 30 according to the present embodiment. Then, explained next is a concrete configuration of a card transfer system and the like, of the card reader 30.

(Structure of Card Reader)

FIG. 10 is a sectional plan view briefly showing a structure of the card reader 30 according to the embodiment of the present invention. FIG. 11 is a longitudinal sectional view briefly showing a structure of the card reader 30 according to the embodiment of the present invention. Incidentally, each arrow in FIG. 11 corresponds to a position having a corresponding reference numeral in FIG. 10. Meanwhile, FIG. 10 and FIG. 11 are already explained in the above description, and therefore a detailed explanation is skipped here.

(Card Searching Process at Start-Up)

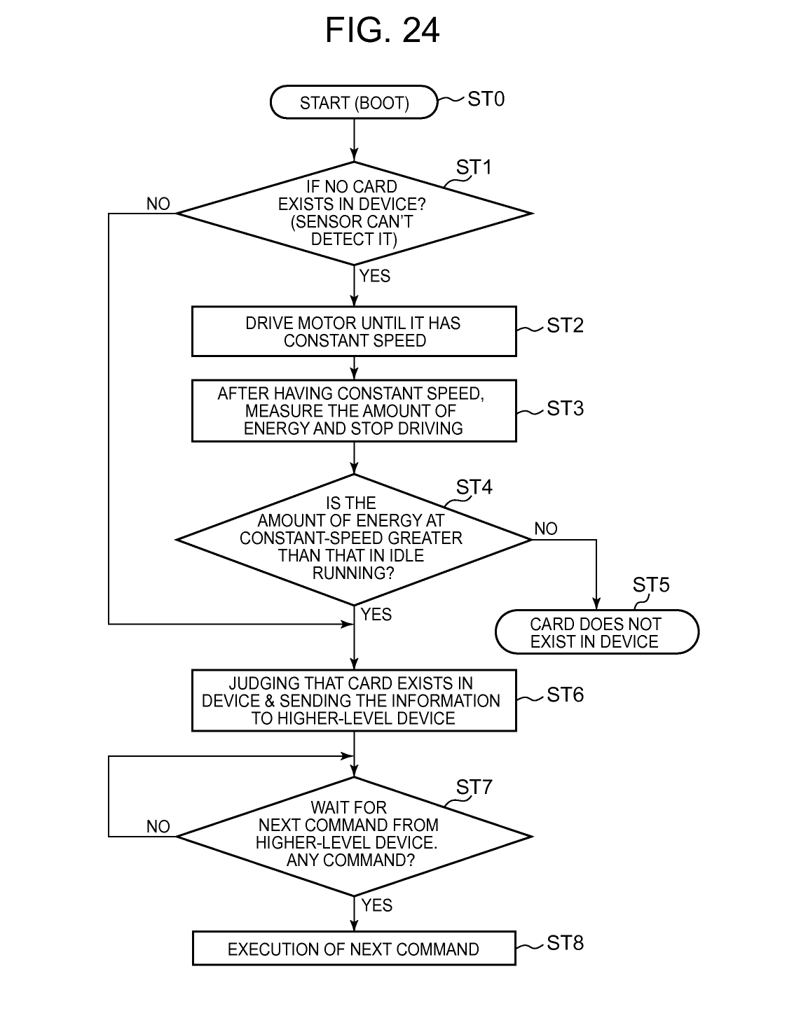

A card searching process at start-up is explained below, with reference to a flowchart. FIG. 24 is a flowchart for explaining a card searching process at the time of start-up, in the card reader 30 according to the present embodiment.

In the card reader 30; for example, at the time of turning on the power (at start-up), or re-starting by turning on the power after a power-off of the card reader 30 due to a power failure and the like, the CPU 41 controls a card searching process to investigate a presence (remaining, or being suspended) of the card CRD at the side of the card reader 30.

For example, the card reader 30 turns off the power due to a power failure and the like; and then re-starts operation by turning on the power (Step ST0 shown in FIG. 24). In response to the process, the CPU 41 makes a judgment on whether no card CRD exists or any card exists in the card reader 30 (device) (Step ST1 shown in FIG. 24), according to a detection signal of each detection sensor of the group of detection sensors 40; for example, the photo-sensors 404 (PD1) through 408 (PD5) that are optical sensors. If it is judged at Step ST1 that no card CRD exists in the device or no detection sensor can detect the card CRD (Step ST1 shown in FIG. 24: Yes), the CPU 41 starts driving the drive motor 16 by way of the driver 37 (Step ST2 shown in FIG. 24). In this case, the CPU 41 drives the drive motor 16 until the motor gets into a constant-speed condition; and subsequently when it is judged that a constant-speed condition is obtained, the CPU 41 measures the amount of energy and stops driving the drive motor 36.

Incidentally, as a case example where it is judged that no card CRD exists in the device or no detection sensor can detect the card CRD, it is assumed that, for example, a transparent card having a magnetic stripe ‘mp’ is lying astride the installation positions of the photo-sensors PD3 and PD4 in the card transfer path 34 and being suspended there, and the transparent card does not exist on the installation positions of the photo-sensors PD2 and PD5, so that the photo-sensors PD3 and PD4 cannot detect the card since the card is transparent. Concretely to describe, such a case example corresponds to a situation where the card CRD is suspended within a range shown with a symbol “CRD” in FIG. 11, and the like.

In the CPU 41 at that time, the measurement unit 411 measures the amount of energy ‘CENG’ of the drive motor 36 driven for a card searching process, in its constant-speed condition, at start-up, according to an output of the encoder 361 as a detection unit for detecting a turning state (rpm and rotational position) of the drive motor 36. Then, in the CPU 41, the judgment unit 412 makes a comparison between the amount of energy ‘CENG’ measured and the amount of energy ‘IENG’ of the drive motor 36 at the time of idle running; the amount of energy ‘IENG’ being stored in the memory unit 413; in order to judge whether the amount of energy ‘CENG’ at its constant-speed running is greater than the amount of energy ‘IENG’ at the time of idle running (Step ST4 shown in FIG. 24).

If it is judged at Step ST4 that the amount of energy ‘CENG’ at its constant-speed running is not greater (smaller) than the amount of energy ‘IENG’ at the time of idle running (Step ST4 shown in FIG. 24: No), it is judged that the card CRD does not exist in the card reader 30 (device) (Step ST5 shown in FIG. 24); and then, for example, information on that judgment is sent to the higher-level device 20, and the card searching process finishes.

On the other hand, if it is judged at Step ST4 that the amount of energy ‘CENG’ at its constant-speed running is greater than the amount of energy ‘IENG’ at the time of idle running (Step ST4 shown in FIG. 24: Yes), or if it is judged at Step ST1 described above that the card CRD exists in the device or a detection sensor detects the card CRD (Step ST1 shown in FIG. 24: No), the CPU 41 makes a judgment that the card CRD exists (being suspended) in the card reader 30 (device) (Step ST6 shown in FIG. 24). Then, the CPU 41 sends the higher-level device 20, information that the card CRD exists (being suspended) in the card reader 30 (device).

Having sent the higher-level device 20 the information that the card CRD exists (being suspended) in the card reader 30 (device), the CPU 41 gets into a standby state waiting for a next command (instruction), such as an ejection command, issued by the higher-level device 20, and judges whether or not a command (instruction) comes up (having been received or not) (Step ST7 shown in FIG. 24). Then, if the CPU 41 judges at Step ST7 that a next command (instruction), such as an ejection command, issued by the higher-level device 20 comes up (has been received) (Step ST7 shown in FIG. 24: Yes), the CPU 41 carries out processing in accordance with the received command (instruction) (Step ST8 shown in FIG. 24).

In the case where the CPU 41 judges that the card CRD exists in the card reader 30, and receives an ejection command from the higher-level device 20, the CPU 41 drive-controls the drive motor 36 by way of the driver 37, in such a way as to eject the card CRD. Meanwhile, a configuration can be made in such a way that; if the CPU 41 judges that the card CRD exists in the card reader 30, and receives a command (instruction) for issuing an alarm from the higher-level device 20, a warning such as an alarm is issued by way of a display unit and an audio processor, which are not illustrated.

In this way, according to the present embodiment; for example, if a transparent card is suspended internally and it is judged that the card CRD exists in the device, it becomes possible to wait for a command (instruction) from a the higher-level device, and (presumably the card CRD may exist in the device, and should the card be ejected or not?) carry out processing.

(Regular Operation of Card Reader 30)

Next, regular operation of the card reader 30 according to the present embodiment is explained in detail, in relation to FIG. 20 through FIG. 23. Explained below is a case where a normal card not being transparent, as well as a transparent card not according to the standards are dealt with. Incidentally, FIG. 20 through FIG. 23 are already explained in the above description, and therefore a detailed explanation is skipped here.

(Turn-on Timing of Detection Signal of Each Sensor & Actual Transfer Movement of Card CRD)

Turn-on timing of a detection signal of each sensor of the group of detection sensors according to the present embodiment and actual transfer movement of the card CRD through the card transfer path 34 are explained below in relation to FIG. 20 and FIG. 21.

FIG. 20 includes diagrams that explain timing when a detection signal of each sensor turns ON. FIG. 21 includes diagrams that show how a card actually moves through a card transfer path. Incidentally, FIG. 20 and FIG. 21 are already explained in the above description, and therefore a detailed explanation is skipped here.

(Operation of Card Reader at the Time of Card Transfer)

Operation of the card reader 30 according to the present embodiment is explained below, wherein an operation in relation to a detection signal of each sensor being focused on in association with a card transfer.

FIG. 22 and FIG. 23 are flowcharts for explaining an operation in relation to a detection signal of each sensor, in association with a card transfer, in the card reader according to the present embodiment. Incidentally, FIG. 20 and FIG. 21 are already explained in the above description, and therefore a detailed explanation is skipped here.

### Advantageous Effect of the Present Embodiment According to the First Invention

As described above, in the card reader 30 according to the present embodiment, if it is basically judged to be an abnormal transfer operation (jam); at the time of ejecting the card CRD out of the card insertion slot 50; the supply control of a write current is carried out in such a way as to delete at least a part of magnetic information recorded on the magnetic stripe ‘mp’, being a magnetic record carrier of the card CRD, by means of supplying a write current to the pre-head 401 (the magnetic head for card detection). For example, a method of using a detection of a card by a photo sensor, and the like, positioned at a side of the card insertion slot 50, as a trigger, can be adopted as a method for detecting an unloading operation of the card CRD having started, after a judgment of an abnormal transfer operation (jam). The supply control of a write current gets started. If supplying an electric current starts immediately at the time of starting the supply control of a write current, in the present embodiment, the electric current is supplied before the card CRD arrives at the installation position of the pre-head 401, so that an electric power is consumed wastefully. Therefore, in the present embodiment, in order to supply an electric current only in a time period that really needs an electric power so as to reduce power consumption, supplying a write current to the pre-head 401 gets started at the time when the card CRD is transferred in a direction toward the side of the card insertion slot 50 for getting ejected, and the pre-head 401 detects a magnetic signal of the magnetic stripe ‘mp’ that is a magnetic record carrier. Thereafter, as the card CRD gets further ejected in the direction toward the side of the card insertion slot 50, and in association with the operation, the magnetic information recorded on the magnetic stripe ‘mp’ of the card CRD is deleted.

Moreover, for a reason such that a wrongdoer does not necessarily pull out a card with a constant force in a smooth manner, the card reader 30 is so configured as to carry out an intermittent current-supply operation in such a way, for example, as to supply a write current to the pre-head 401 for a predetermined time, e.g., five seconds, and then to subsequently stop supplying the write current. Also, a configuration may be established in such a way that the card reader 30 repeats a supply control of a write current after the judgment of an abnormal transfer operation, described above, including this intermittent current-supply operation. By adopting an intermittent current-supply operation in this way, it is possible to further reduce the power consumption.

For example, a method of using a fact that; owing to a predetermined force applied to the card CRD in the direction toward the side of the card insertion slot 50, a load is applied to the drive motor 36 for operating the card transfer unit 35 so as to increase the amount of energy of the drive motor 36; as a trigger, can also be adopted as a method for detecting an unloading operation of the card CRD having started, after a judgment of an abnormal transfer operation (jam).

In this way, the CPU 41 can make a judgment on whether or not the amount of energy (load) of the motor increases, as a trigger for starting the supply control of a write current. Incidentally, it is also possible to adopt another configuration in such a way that a method of using a detection result of a detection sensor as a trigger for starting the supply control of a write current, as described above, is applied in combination.

Moreover, in the present embodiment, a configuration described below can also be adopted. After starting the supply control of a write current to the pre-head 401, the CPU 41 makes a comparison between the first energy amount obtained by way of measuring the amount of energy of the drive motor 36 and the second energy amount of the motor stored in the storage unit, on the basis of a detection result of the encoder 361 working as a detection unit; and then, in the case where the first energy amount measured has decreased to the second energy amount that has been stored, the supply of the write current to the pre-head 401 is stopped. Moreover, after stopping the supply of the write current to the pre-head 401, the CPU 41 makes a comparison between the first energy amount obtained by way of measuring the amount of energy of the motor 36 and the second energy amount of the motor stored in the storage unit, on the basis of a detection result of the encoder 361 working as a detection unit; and then, in the case where the first energy amount measured becomes greater than the second energy amount that has been stored, the supply of the write current to the pre-head 401 resumes.

It is also possible to establish a configuration in such a way as to make a combination of steps of stopping and resuming the current supply, for example, as to repeat those steps. Moreover, these steps can be carried out, being either independent from, or in combination with, the intermittent current-supply operation at a predetermined time interval as described above. This kind of configuration produces a benefit of an efficient control of power consumption.

Therefore, according to the present embodiment, the following effects can be obtained. That is to say; even if a card is stolen by way of an illicit behavior, it is still possible at least to avoid a fraudulent use of magnetic data. In other words, even though stealing the card by way of phishing happens, it is still possible at least to avoid a worst case scenario, as far as no magnetic data is stolen. Moreover, a method of protecting a card from phishing, by way of adding a mechanical structure, needs an additional installation of the mechanical structure as well as adding hardware for operating the mechanical structure. Furthermore, in the case of adding the mechanical structure, it is necessary to secure a space for the installation of the mechanical structure. On the other hand, in the case of a method for detecting an abnormal condition and deleting magnetic information of a card that is in danger of phishing, as the present embodiment represents, only a change is an addition of a circuit for supplying an electric current to a magnetic head for detecting magnetism, which is already installed, so that it becomes possible to avoid making the device larger. Moreover, even if it becomes necessary to change a configuration of the head, a new head can easily be manufactured by making use of the magnetic writable head conventionally used. Furthermore, though a considerable amount of electric current needs to be supplied for deleting magnetism, an effective reduction control on power consumption is achieved by adopting a new algorithm for a detection of an abnormal condition (a trigger such as jam) and a subsequent detection of the card having been moved (namely, a wrongdoer has begun an operation of pulling out the card).

### Advantageous Effect of the Present Embodiment According to the Second Invention

As described above, in the card reader 30 according to the present embodiment; at the time of turning on the power (at start-up), or re-starting by turning on the power after a power-off of the card reader 30 due to a power failure and the like, a card searching process is carried out in order to investigate a presence (remaining, or being suspended) of the card CRD at the side of the card reader 30. The CPU 41 measures the amount of energy ‘CENG’ of the drive motor 36 driven for a card searching process, in its constant-speed condition, at start-up, according to an output of the encoder 361 as a detection unit for detecting a turning state (rpm and rotational position) of the drive motor 36. The CPU 41 makes a comparison between the amount of energy ‘CENG’ measured and the amount of energy ‘IENG’ of the motor at the time of idle running; the amount of energy ‘IENG’ being stored in the memory unit 413; and then makes a judgment on whether or not the card C exists in the card reader 30 (device). If the amount of energy ‘CENG’ measured is greater than the amount of energy ‘IENG’ at the time of idle running, the CPU 41 makes a judgment that the card C exists in the card reader 30; and contrarily if the former is smaller than the latter, the CPU 41 makes a judgment that the card CRD does not exist in the card reader 30. In the case where the CPU 41 judges that the card CRD exists in the card reader 30, and receives an ejection command issued from the higher-level device 20, the CPU 41 drive-controls the drive motor 36 by way of the driver 37, in such a way as to eject the card CRD. Meanwhile, a configuration can be made in such a way that; if the CPU 41 judges that the card CRD exists in the card reader 30, and receives an alarming command issued from the higher-level device 20, a warning such as an alarm is issued by way of a display unit and an audio processor, which are not illustrated.

Therefore, according to the present embodiment, the following effects can be obtained. That is to say; in the case of a conventional card reader, it is necessary to drive the drive motor 36 unconditionally in a direction for ejecting the card CRD (for a distance of the ejection) without any command (instruction) from the higher-level device 20, even though it is judged that the card CRD does not exist in the device. On the other hand, according to the present embodiment; for example, when the card CRD being transparent remains internally, and it is judged that the card CRD exists in the device (in the card reader 30), a process can be carried out after waiting for a command (instruction) issued from the higher-level device 20 (presumably a card may exist in the device, and should the card be ejected or not?).

### Other embodiments

Though the explanation is made on a case example that the card CRD is a magnetic card, in the embodiment described above, the same processing can be carried out for an IC card as well, so as to achieve a similar effect. As described above, in the case of the card reader 30 of the present embodiment, a contact for an IC card is located at a predetermined position in the device, and pressing an IC contact lever located at a rear side by the card CRD makes the contact lower onto the card CRD; and when the contact arrives at a lowest position, a sensor respond. Therefore, even though the card CRD inserted is a transparent card and a card position cannot accurately be recognized, even the transparent card can be dealt with, by way of operating the drive motor 36 backward until the IC contact sensor responds, as far as it is known that the card CRD is internally positioned.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A card medium processing device for carrying out a predetermined process for a card medium in which a magnetic record carrier for recording magnetic information is formed, the card medium processing device comprising:
a medium transfer unit structured to transfer the card medium along a transfer path, while the card medium being in contact, and the card medium having been inserted from an insertion slot;
a motor structured to drive the medium transfer unit;
a magnetic head installed in an area of the insertion slot, the magnetic head structured to detect the magnetic record carrier of the card medium;
a detection sensor structured to detect a presence and a position of the card medium in the transfer path; and
a control unit structured to control a transfer of the card medium by driving the motor in accordance with a detection result of the detection sensor;
wherein, if it is judged to be an abnormal transfer operation in which the card medium is not normally transferred, the control unit is structured to, at the time of ejecting the card medium out of the insertion slot, supply a write current to the magnetic head to delete at least a part of magnetic information recorded on the magnetic record carrier of the card medium.

2. The card medium processing device according to claim 1:
wherein, after a judgment of an abnormal transfer operation, and if the detection sensor detects the card medium, the control unit supplies the write current to the magnetic head.

3. The card medium processing device according to claim 1:
wherein, if the card medium is transferred in a direction toward the insertion slot for getting ejected, and the magnetic head detects a magnetic signal of the magnetic record carrier, the control unit supplies the write current to the magnetic head.

4. The card medium processing device according to claim 1:
wherein the control unit is structured to perform an intermittent current-supply operation in such a way as to supply the write current to the magnetic head for a predetermined time, and then to subsequently stop supplying the write current.

5. The card medium processing device according to claim 4:
wherein the control unit repeats the supply control of the write current, subsequent to the judgment of an abnormal transfer operation, including the intermittent current-supply operation.

6. The card medium processing device according to claim 1:
wherein the card medium processing device comprises:
a detection unit structured to detect a turning state of the motor; and
a storage unit structured to store beforehand the amount of energy of the motor, corresponding to either an abnormal transfer operation in which the card medium is not normally transferred through the transfer path, or a normal transfer operation; and
after the judgment of an abnormal transfer operation, in a state in which the detection sensor is not sensing the card medium, the control unit is structured to make a comparison between a first energy amount obtained by way of measuring the amount of energy of the motor and a second energy amount of the motor stored in the storage unit, on the basis of a detection result of the detection unit; and then in the case where the first energy amount measured becomes greater than the second energy amount that has been stored, the control unit is structured to judge that the card medium is transferred toward the side of the insertion slot, and then starts the supply control of the write current to the magnetic head by using the judgment as a trigger.

7. The card medium processing device according to claim 6:
wherein, after starting a supply of the write current to the magnetic head, the control unit is structured to make a comparison between the first energy amount obtained by way of measuring the amount of energy of the motor and the second energy amount of the motor, stored in the storage unit, on the basis of a detection result of the detection unit; and then in the case where the first energy amount measured has decreased to the second energy amount that has been stored, the supply of the write current to the magnetic head is stopped.

8. The card medium processing device according to claim 7:
wherein, after stopping the supply of the write current to the magnetic head, the control unit is structured to make a comparison between the first energy amount obtained by way of measuring the amount of energy of the motor and the second energy amount of the motor stored in the storage unit, on the basis of a detection result of the detection unit; and then, in the case where the first energy amount measured becomes greater than the second energy amount that has been stored, the supply of the write current to the magnetic head resumes.

9. A card medium processing method for a card medium processing device, the method comprising:
transferring a card medium along a transfer path with a medium transfer unit, while the card medium being in contact, and the card medium having been inserted from an insertion slot;
driving the medium transfer unit with a motor;
detecting a magnetic record carrier of the card medium with a magnetic head installed in an area of the insertion slot; and
detecting a presence and a position of the card medium in the transfer path with a detection sensor;
wherein a transfer of the card medium is controlled by driving the motor in accordance with a detection result of the detection sensor; and
if it is judged to be an abnormal transfer operation in which the card medium is not normally transferred, at the time of ejecting the card medium out of the insertion slot, a supply control of a write current is carried out in such a way as to delete at least a part of magnetic information recorded on the magnetic record carrier of the card medium, by means of supplying the write current to the magnetic head.

10. The card medium processing method according to claim 9:
wherein, after a judgment of an abnormal transfer operation, and moreover if the detection sensor detects the card medium, the supply control of the write current to the magnetic head gets started.

11. The card medium processing method according to claim 9:
wherein, if the card medium is transferred in a direction toward the side of the insertion slot for getting ejected, and the magnetic head detects a magnetic signal of the magnetic record carrier, supplying the write current to the magnetic head gets started.

12. The card medium processing method according to claim 9:
wherein an intermittent current-supply operation is carried out in such a way as to supply the write current to the magnetic head for a predetermined time, and then to subsequently stop supplying the write current.

13. The card medium processing method according to claim 12:
wherein the supply control of the write current, subsequent to the judgment of an abnormal transfer operation, including the intermittent current-supply operation, is repeated.

14. The card medium processing method according to claim 9:
wherein a storage unit stores beforehand the amount of energy of the motor, corresponding to either an abnormal transfer operation in which the card medium is not normally transferred through the transfer path, or a normal transfer operation; and
after the judgment of an abnormal transfer operation, under conditions where the detection sensor is not sensing the card medium, a comparison is made between a first energy amount obtained by way of measuring the amount of energy of the motor and a second energy amount of the motor stored in the storage unit, on the basis of a detection result of the detection unit that detects a turning state of the motor; and
then, in the case where the first energy amount measured becomes greater than the second energy amount that has been stored, it is judged that the card medium is transferred toward the side of the insertion slot, and the supply control of the write current to the magnetic head gets started by using the judgment as a trigger.

15. The card medium processing method according to claim 14:
wherein, after starting a supply of a write current to the magnetic head, a comparison is made between the first energy amount obtained by way of measuring the amount of energy of the motor and the second energy amount of the motor, stored in the storage unit, on the basis of a detection result of the detection unit; and
then in the case where the first energy amount measured has decreased to the second energy amount that has been stored, the supply of the write current to the magnetic head is stopped.

16. The card medium processing method according to claim 15:
wherein, after stopping the supply of the write current to the magnetic head, a comparison is made between the first energy amount obtained by way of measuring the amount of energy of the motor and the second energy amount of the motor stored in the storage unit, on the basis of a detection result of the detection unit; and then, in the case where the first energy amount measured becomes greater than the second energy amount that has been stored, the supply of the write current to the magnetic head resumes.

17-27. (canceled)
